(19) United States
(12) Patent Application Publication
(10) Pub. No.: US 2025/0342742 A1
(43) Pub. Date: Nov. 6, 2025

(54) SYSTEMS AND METHODS FOR DYNAMICALLY CONTROLLING DISPLAYED SYMBOLS IN ELECTRONIC GAMING

(71) Applicant: Aristocrat Technologies, Inc., Las Vegas, NV (US)

(72) Inventors: Ridhima Jain, New Delhi (IN); Jennifer Mizzi, Ewa Beach, HI (US); Erick Ching, Cedar Park, TX (US); Nathan Warms, Austin, TX (US); Rogelio Decasa, JR., Renton, WA (US)

(21) Appl. No.: 18/654,836

(22) Filed: May 3, 2024

(51) Int. Cl. G07F 17/32; G07F 17/34

(52) U.S. Cl. CPC G07F 17/3211; G07F 17/34

(57) ABSTRACT

An electronic gaming system is described. The electronic gaming system is configured to for a first play of the electronic game, cause a subset of reels to spin. The electronic gaming system is also configured to, based on at least one output symbol being displayed for the first play, cause initiation of a second play of the electronic game wherein the at least one additional output symbol is held and not replaced for the second play. The electronic gaming system is also configured to, after a last play, cause an output amount associated with displayed output symbols to be provided.

### TECHNICAL FIELD

The field of disclosure relates generally to electronic gaming, and more specifically, to systems and methods for dynamically controlling displayed symbols in electronic gaming.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic gaming device including at least one memory with instructions stored thereon and at least one processor in communication with the at least one memory is described. The instructions, when executed by the at least one processor, cause the at least one processor to cause display of an electronic game for a plurality of plays on a plurality of reels wherein the plurality of reels include a plurality of symbols and wherein a first reel of the plurality of reels includes a trigger symbol that triggered the electronic game. The instructions also cause the at least one processor to, for a first play of the electronic game, cause each reel of a subset of the plurality of reels to spin, the subset including each reel other than the first reel wherein one or more output symbols on the subset are held and not replaced for the first play and wherein symbols other than the one or more output symbols on the subset are replaced for the first play. The instructions further cause the at least one processor to, based on at least one additional output symbol being displayed for the first play, cause initiation of a second play of the electronic game wherein the one or more output symbols, including the at least one additional output symbol, are held and not replaced for the second play and wherein symbols other than the one or more output symbols on the subset are replaced for the second play. The instructions also cause the at least one processor to, after a last play of the plurality of plays, cause an output amount associated with the one or more output symbols to be provided wherein the output amount includes a sum of output amounts associated with output symbols on one or more reels of the plurality of reels, the one or more reels including consecutive reels of the plurality of reels that include at least one output symbol thereon.

In another aspect, at least one non-transitory computer-readable storage medium with instructions stored thereon is described. The instructions, in response to execution by at least one processor, cause the at least one processor to cause display of an electronic game for a plurality of plays on a plurality of reels wherein the plurality of reels include a plurality of symbols and wherein a first reel of the plurality of reels includes a trigger symbol that triggered the electronic game. The instructions also cause the at least one processor to, for a first play of the electronic game, cause each reel of a subset of the plurality of reels to spin, the subset including each reel other than the first reel wherein one or more output symbols on the subset are held and not replaced for the first play and wherein symbols other than the one or more output symbols on the subset are replaced for the first play. The instructions further cause the at least one processor to, based on at least one additional output symbol being displayed for the first play, cause initiation of a second play of the electronic game wherein the one or more output symbols, including the at least one additional output symbol, are held and not replaced for the second play, and wherein symbols other than the one or more output symbols on the subset are replaced for the second play. The instructions also cause the at least one processor to, after a last play of the plurality of plays, cause an output amount associated with the one or more output symbols to be provided, wherein the output amount includes a sum of output amounts associated with output symbols on one or more reels of the plurality of reels, the one or more reels including consecutive reels of the plurality of reels that include at least one output symbol thereon.

In another aspect, a method of electronic gaming implemented by at least one processor in communication with at least one memory is described. The method includes causing display of an electronic game for a plurality of plays on a plurality of reels wherein the plurality of reels includes a plurality of symbols and wherein a first reel of the plurality of reels includes a trigger symbol that triggered the electronic game. The method also includes, for a first play of the electronic game, causing each reel of a subset of the plurality of reels to spin, the subset including each reel other than the first reel wherein one or more output symbols on the subset are held and not replaced for the first play and wherein symbols other than the one or more output symbols on the subset are replaced for the first play. The method further includes, based on at least one additional output symbol being displayed for the first play, causing initiation of a second play of the electronic game wherein the one or more output symbols, including the at least one additional output symbol, are held and not replaced for the second play, and wherein symbols other than the one or more output symbols on the subset are replaced for the second play. The method also includes, after a last play of the plurality of plays, causing an output amount associated with the one or more output symbols to be provided wherein the output amount includes a sum of output amounts associated with output symbols on one or more reels of the plurality of reels, the one or more reels including consecutive reels of the plurality of reels that include at least one output symbol thereon.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 illustrates an example screenshot and/or interface of a base game, as described herein.

FIG. 5 illustrates another example screenshot and/or interface of the base game shown in FIG. 4

FIG. 6 illustrates another example screenshot and/or interface of the base game shown in FIG. 4

FIG. 7 illustrates an example screenshot and/or interface of a re-spin game being triggered from the base game shown in FIG. 4.

FIG. 8 illustrates an example screenshot and/or interface of a re-spin game, as described herein.

FIG. 9 illustrates an example screenshot and/or interface of the re-spin game shown in FIG. 8.

FIG. 10 illustrates an example screenshot and/or interface of the re-spin game shown in FIG. 8.

FIG. 11 illustrates an example screenshot and/or interface of the re-spin game shown in FIG. 8.

FIG. 12 illustrates another example screenshot and/or interface of the re-spin game shown in FIG. 8.

FIG. 13 illustrates an example screenshot and/or interface of the re-spin game shown in FIG. 12.

FIG. 14 illustrates an example screenshot and/or interface of the re-spin game shown in FIG. 12.

FIG. 15 illustrates an example screenshot and/or interface of the re-spin game shown in FIG. 12.

FIG. 16 illustrates an example screenshot and/or interface of a free spin game being triggered from the base game shown in FIG. 4.

FIG. 17 illustrates an example screenshot and/or interface of a re-spin game being triggered from the free spin game triggered in FIG. 16.

FIG. 18 illustrates an example screenshot and/or interface of the re-spin game triggered in FIG. 17.

FIG. 19 illustrates another example screenshot and/or interface of the re-spin game shown in FIG. 18.

FIG. 20 illustrates another example screenshot and/or interface of the re-spin game shown in FIG. 18.

FIG. 21 illustrates another example screenshot and/or interface of the re-spin game shown in FIG. 18.

FIG. 22 illustrates an example screenshot and/or interface of the free spin game triggered in FIG. 16.

FIG. 23 illustrates another example screenshot and/or interface of the free spin game triggered in FIG. 16.

FIG. 24 illustrates an example data structure and/or table for dynamically controlling displayed symbols, in accordance with the present disclosure.

FIG. 25 illustrates an example method for dynamically controlling displayed symbols, in accordance with the present disclosure.

FIGS. 26-45 illustrate additional example screenshots and/or interfaces for dynamically controlling displayed symbols in electronic gaming, in accordance with the present disclosure.

### DETAILED DESCRIPTION

Described herein are systems and methods for dynamically controlling displayed symbols in electronic gaming. For instance, certain symbols may be held for multiple plays of an electronic game and/or different electronic games and certain new symbols may dynamically determined based upon one or more data structures (e.g., tables) stored in memory and which symbols are being held.

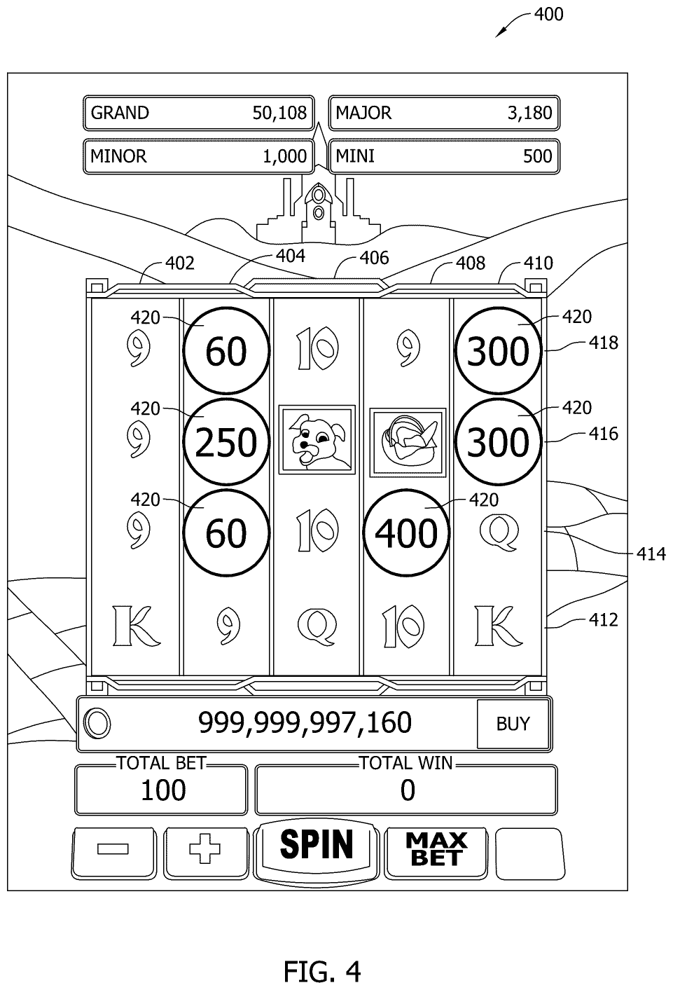

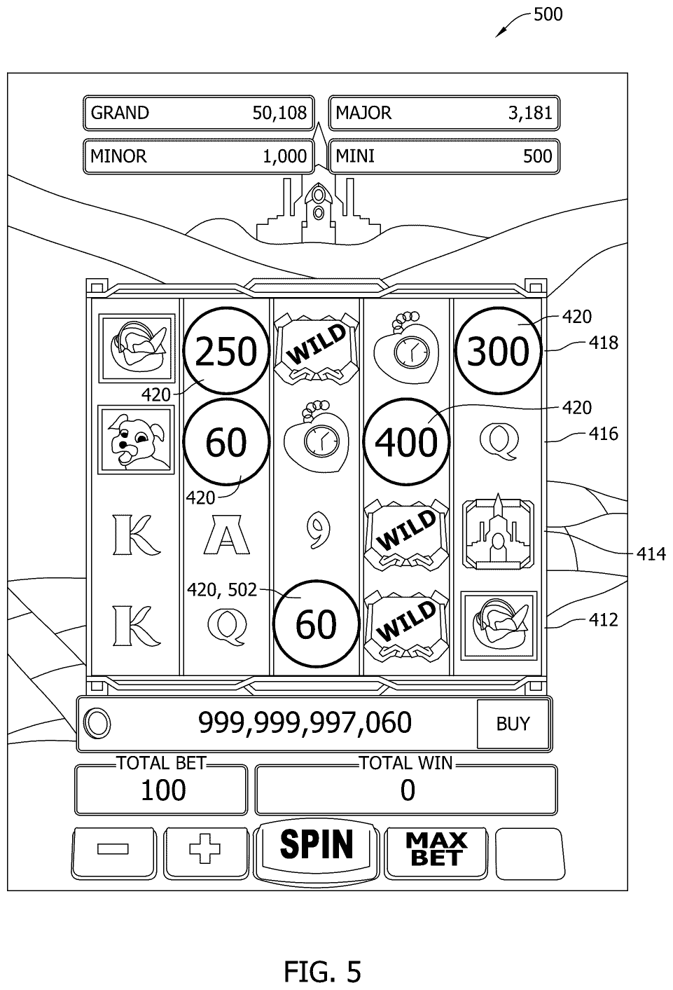

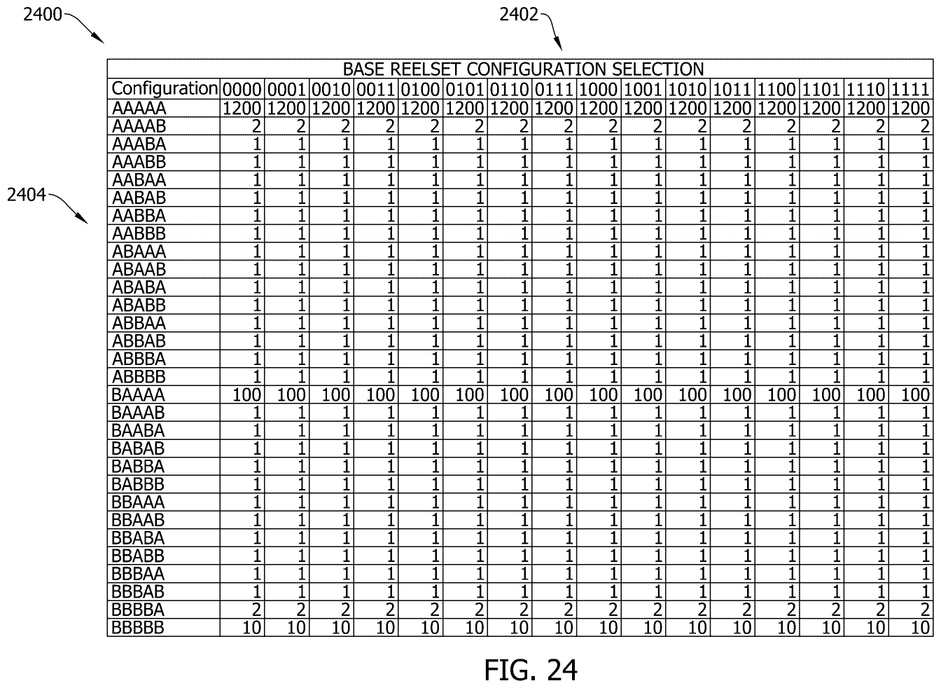

In the example embodiment, during a base game, a 4×5 matrix may be provided (e.g., or any other size matrix). See FIGS. 4 and 5, for instance. A custom reel set selection may be provided for each reel of the matrix. For instance, for each new spin, output symbols (e.g., cash-on-reel (COR) symbols, prize-on-reel symbols, what you see is what you get (WYSIWYG) symbols, or any other symbols associated with an output amount that is displayed thereon) may be “floated” (e.g., caused to move up one or more rows) and the state of the reels may be analyzed. The state of the reels may be analyzed as a sequence of bits, where each reel without an output symbol is represented by a “0” in the sequence and each reel with an output symbol is represented by a “1” in the sequence. The sequence may be concatenated (e.g., 0100 for a first reel with no output symbol, a second reel with an output symbol, and third and fourth reels with no output symbol). The determined sequence may be used in combination with a randomly determined configuration for each reel (e.g., either configuration “A” or configuration “B,” where each configuration is a reel strip or plurality of symbols) and a weighted table to randomly determine symbols for each symbol position of the reels. See FIG. 24, for instance. Determined symbols that are overlaid by an output symbol may be replaced with a relatively low value symbol.

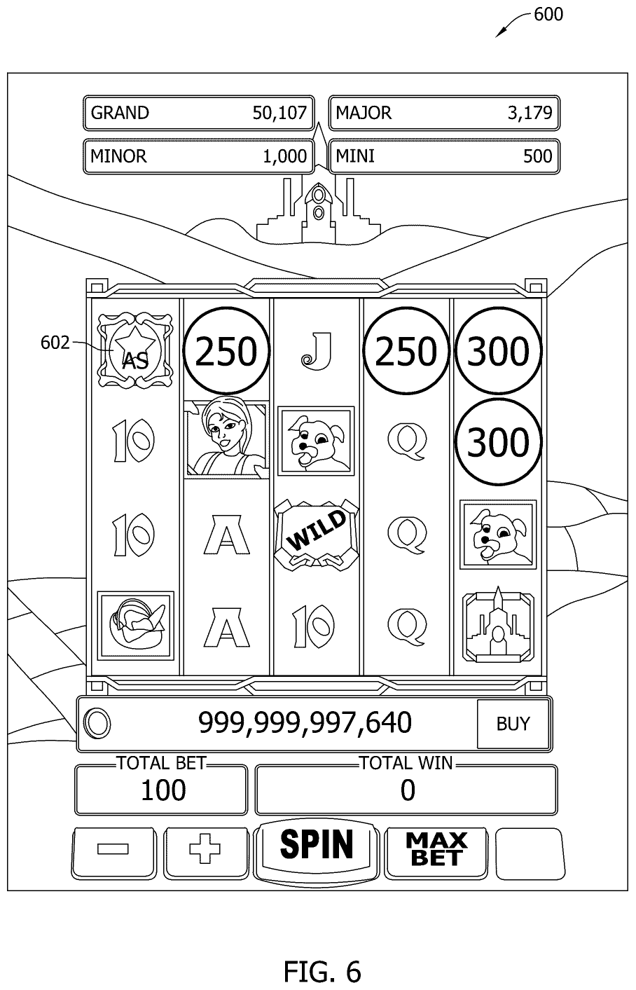

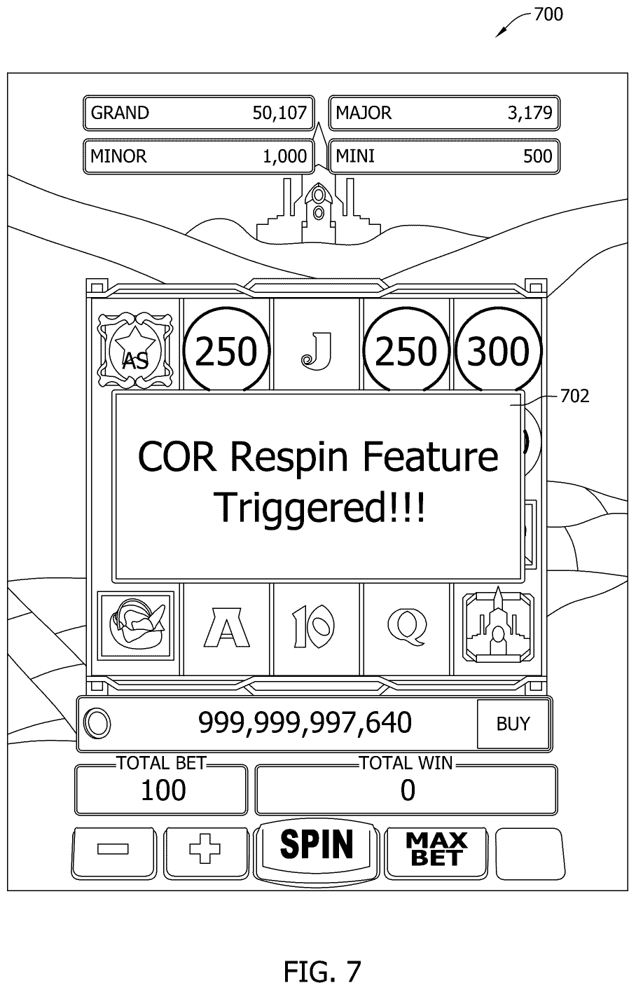

During base game spins, when a trigger symbol (e.g., an activator symbol) lands on a first reel, all of the displayed output symbols (e.g., if any are displayed) and all symbols on the first reel (e.g., including the trigger symbol) may be locked in their positions and a re-spin game may be initiated. See FIGS. 6 and 7, for instance. The first reel may never be re-spun during the re-spin game.

During the re-spin game, additional spins may be provided when a new output symbol lands and is locked. The re-spin game may end when no new output symbol lands during a play of the re-spin game. Reels for the re-spin game may be generated as described above with respect to the base game. Output symbols may not “float” in the re-spin game. When the reels stop, output amounts based on the symbols are determined and provided.

Different types of output symbols may be provided in any of the games described herein. For instance, a Lo, Mid, or High determination for a new output symbol may be randomly made, and based on that determination, the new output symbol may be randomly selected from the one of the Lo, Mid, or High groups of symbols.

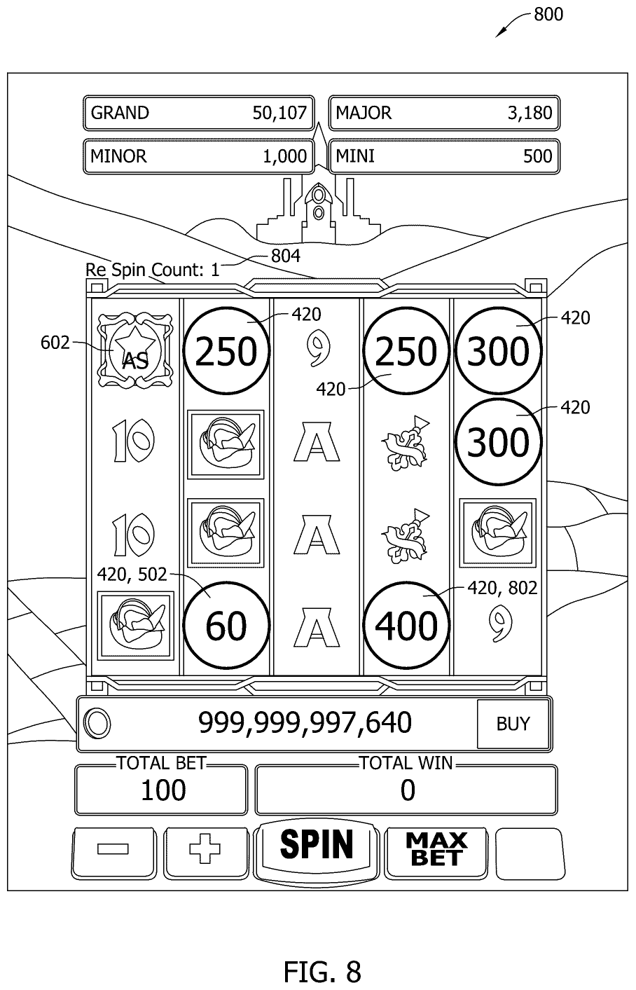

In the re-spin game, when no new output symbol lands during a play, a left-to-right cadence may be utilized to determine a payout. In other words, output amounts associated with displayed output symbols may be provided for consecutive reels, from left-to-right, that have output symbols displayed thereon (e.g., and not from output symbols on reels to the right of any reel, other than the first reel (e.g., displaying the trigger symbol), that does not have an output symbol displayed thereon). See FIGS. 8-11, for instance, where output amounts associated with output symbols on the second reel are provided (e.g., and not output amounts associated with output symbols on the fourth and fifth reels, because no output symbol is provided on the third reel).

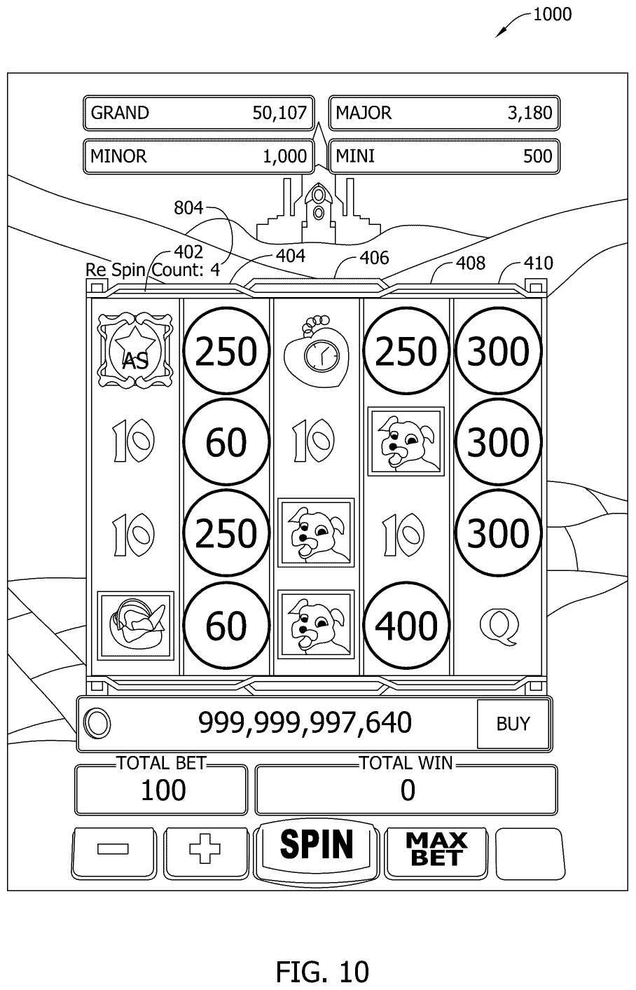

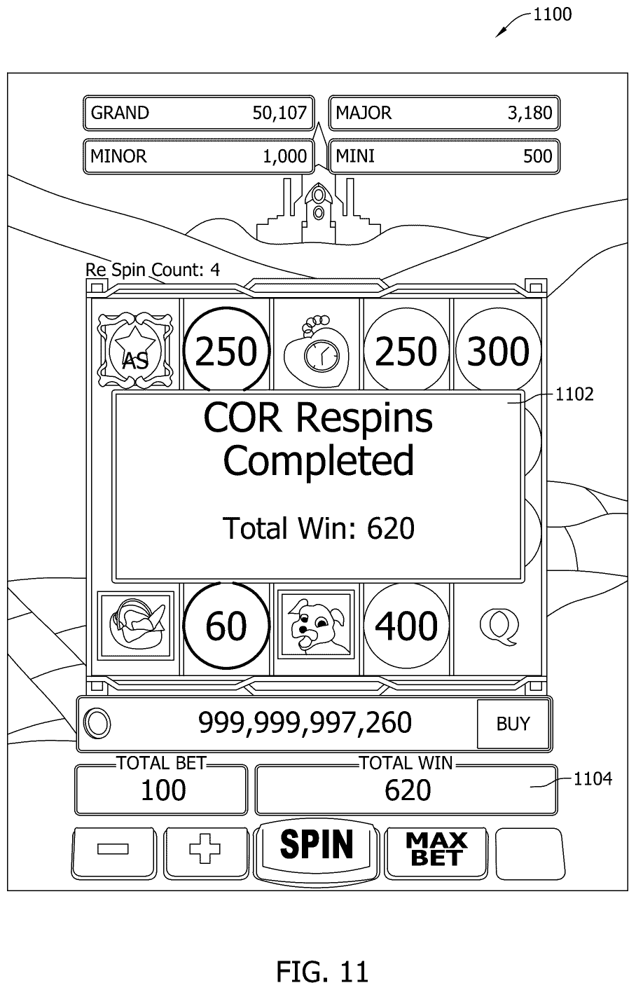

All or a subset of output symbols from the re-spin game may be carried back to the base game (e.g., see transition from FIGS. 10, 11 to FIG. 4, where output symbols from FIGS. 10, 11 are shifted up one row, and output symbols remaining in the matrix (e.g., not those that “floated” off the top of the matrix) are provided in the base game in FIG. 4).

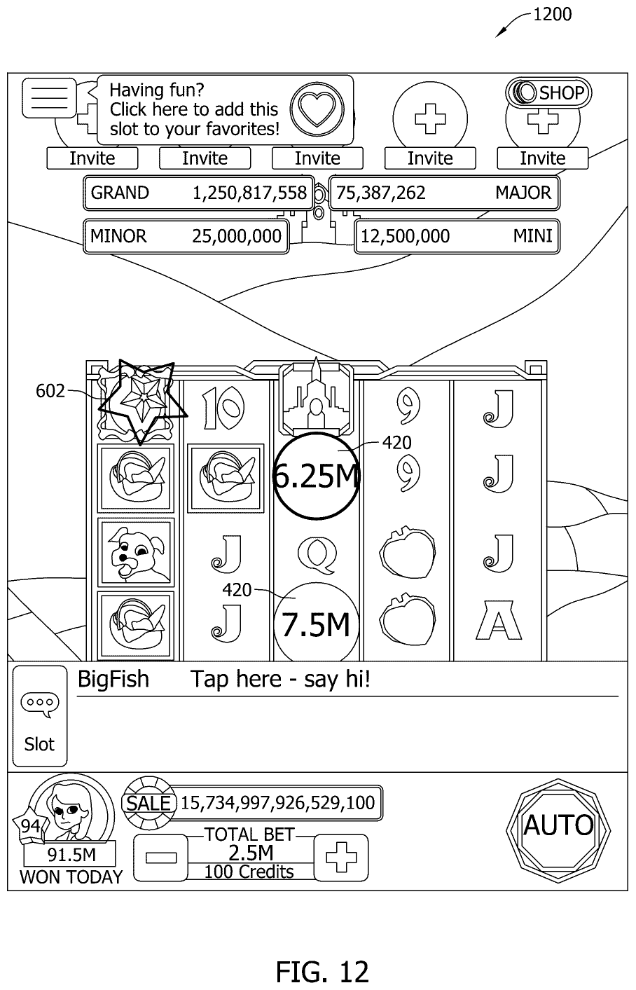

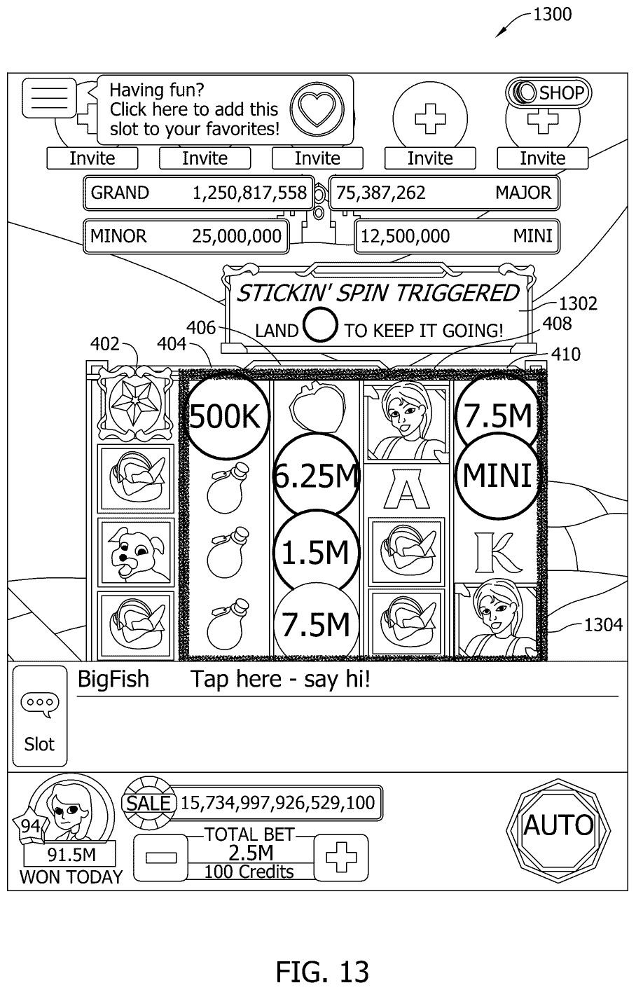

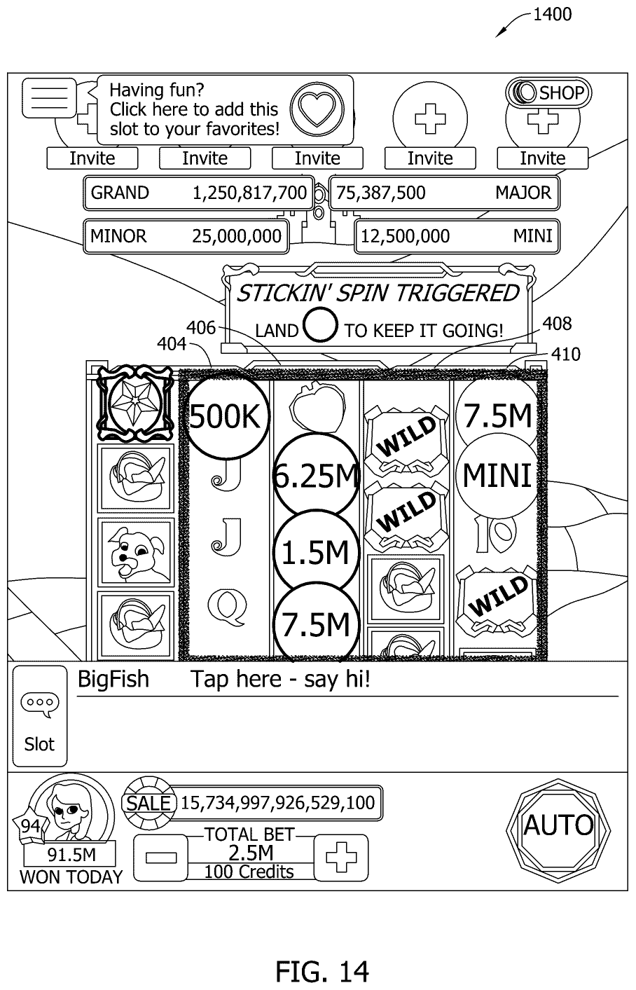

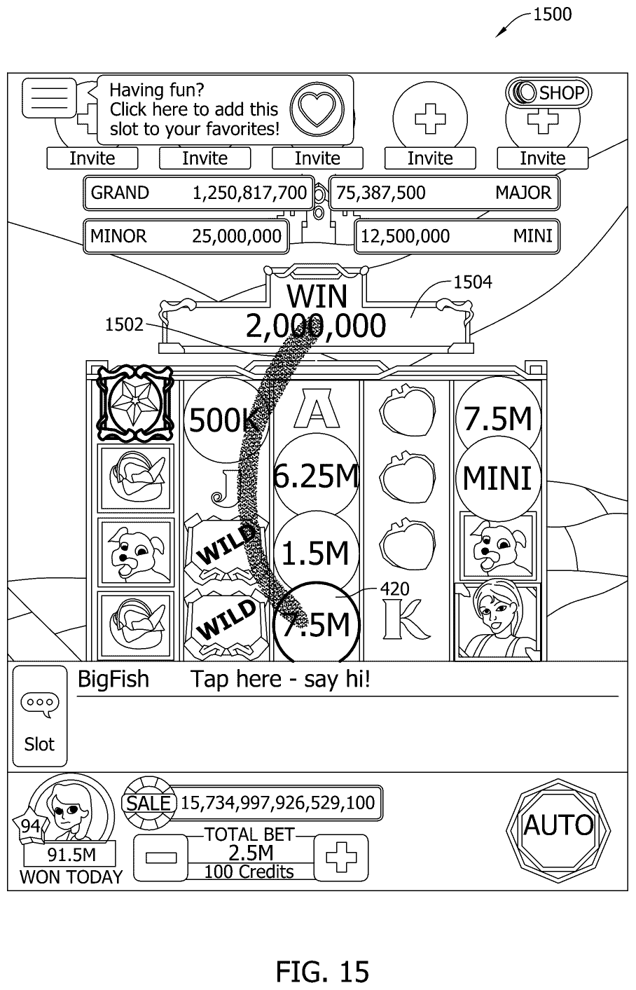

During the re-spin game, different animations may be utilized to present information to players in a clear and efficient manner. As one example, the trigger symbol may be animated to communicate when the re-spin game has been triggered (e.g., see FIG. 12). Further, an animation may be provided on and/or surrounding reels to be spun in the re-spin game (e.g., each reel other that the first reel, displaying the trigger symbol, as shown in FIG. 13). As another example, output symbols included on consecutive reels from left-to-right with output symbols displayed thereon may be animated to communicate that the output amounts associated therewith will be provided at the end of the re-spin game (e.g., and not symbols on reels to the right of a reel with no output symbol displayed thereon), as shown in FIG. 14. Another animation may also be provided as output amounts are being summed to indicate which output amounts are being included in a total output amount for the re-spin game (e.g., see FIG. 15).

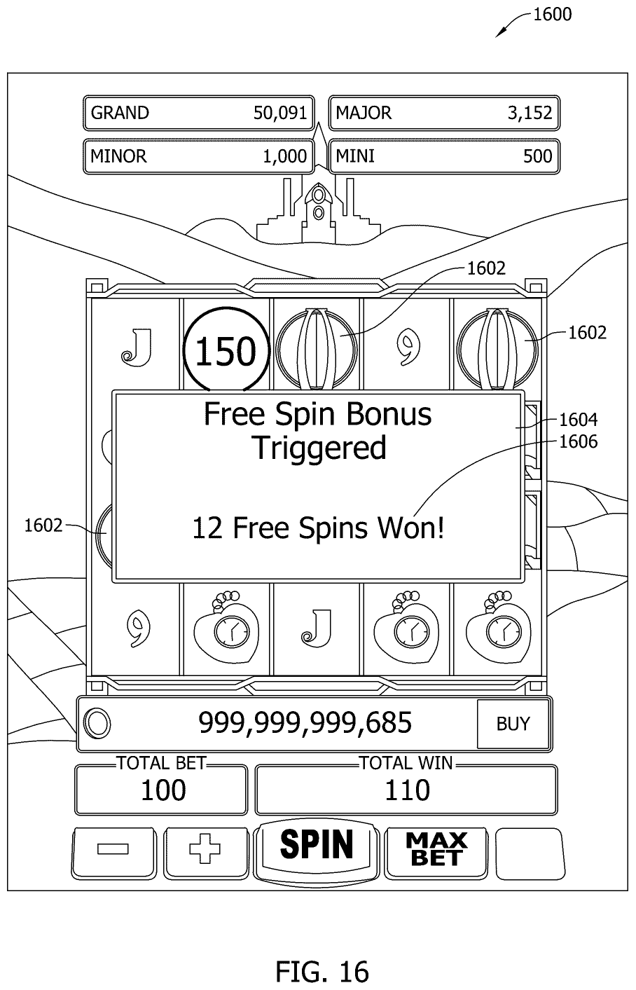

The re-spin game may be triggered from a base game or another game, as described herein. For instance, FIGS. 16-23 illustrate play of a free spin game where, during the free spin game, the re-spin game is triggered, as explained below in further detail.

The technical problems addressed herein include at least one of: (i) inability of known systems to hold and/or shift output symbols on certain reels, including while transitioning between different electronic games, while maintaining RTP; (ii) inability of known systems to efficiently communicate active reels and/or reels on which output symbols may be provided; (iii) inability of known systems to efficiently communicate which output symbols of a plurality of output symbols are associated with output amounts that will be provided and which output symbols of the plurality of output symbols are associated with output amounts that will not be provided; (iv) inability of known systems to dynamically and/or randomly determine reel strips and/or pluralities of symbols to be applied to a plurality of reels based at least in part upon a random determination and/or a determination of which reels of the plurality of reels include an output symbol displayed thereon; and (v) inability of known systems to control RTP while dynamically and/or randomly determining reel strips and/or pluralities of symbols to be applied to a plurality of reels, as explained herein.

The resulting technical effects and/or technical benefits achieved by this disclosure include at least one of: (i) ability to hold and/or shift output symbols on certain reels, including while transitioning between different electronic games, while maintaining RTP; (ii) ability to efficiently communicate active reels and/or reels on which output symbols may be provided; (iii) ability to efficiently communicate which output symbols of a plurality of output symbols are associated with output amounts that will be provided and which output symbols of the plurality of output symbols are associated with output amounts that will not be provided; (iv) ability to dynamically and/or randomly determine reel strips and/or pluralities of symbols to be applied to a plurality of reels based at least in part upon a random determination and/or a determination of which reels of the plurality of reels include an output symbol displayed thereon; (v) ability to control RTP while dynamically and/or randomly determining reel strips and/or pluralities of symbols to be applied to a plurality of reels based at least in part upon a random determination and/or a determination of which reels of the plurality of reels include an output symbol displayed thereon; (vi) displaying large quantities of complex information in a relatively small display area; (vii) communicating complex information with easy-to-understand animations on a display; (viii) clearly indicating when a player has entered a particular game; (ix) efficiently communicating different game rules for games on a display during game play; and (x) providing versatility as to which devices (e.g., EGMs, mobile devices, etc.) the games described herein may be played on because of the efficient display area designs described herein.

Various interface improvements are provided herein to efficiently and effectively communicate information. For instance, various animations are provided to communicate when a re-spin game has been triggered, which reels are re-spun in the re-spin game and which reel or reels are not re-spun in the re-spin game, and which output amounts are being summed and provided, as a few examples.

Example embodiments described herein may be provided in combination or in isolation to summarize and present game mechanics in a manner that improves the efficiency of computer systems (e.g., electronic gaming systems including electronic gaming devices). Each example system provides an improved user interface displaying a limited set of information to players, potentially within a small screen, such that players can more quickly understand the current status of the game and navigate to the next play of the game. The systems and methods provide improved display device functionality (e.g., on a gaming device) by providing multiple visual indicators that communicate game mechanics described herein to players. The systems and methods provided herein also improve display and device efficiency by eliminating the need for complex information pages describing game mechanics to players. Because of at least the easily-understood animations, symbols, and indicators displayed, the games described herein can be played and understood on a single screen substantially smaller than some of the EGMs described herein (e.g., a mobile device such as a cell phone), thus removing the need for multiple displays with complex information screens including lengthy text.

Further, different specific lookups may be utilized during play of the example games described herein in order to properly provide the games described herein while controlling RTP. For instance, various tables (e.g., FIG. 24), such as weighted tables, may be stored in memory to determine which symbol should be displayed at each symbol position for an instance of a game. For instance, to control RTP, tables such as the one shown in FIG. 24 may be utilized, along with one or more random determinations, in order to dynamically and/or randomly determine reel strips and/or pluralities of symbols to be applied to a plurality of reels based at least in part upon a random determination and/or a determination of which reels of the plurality of reels include an output symbol displayed thereon

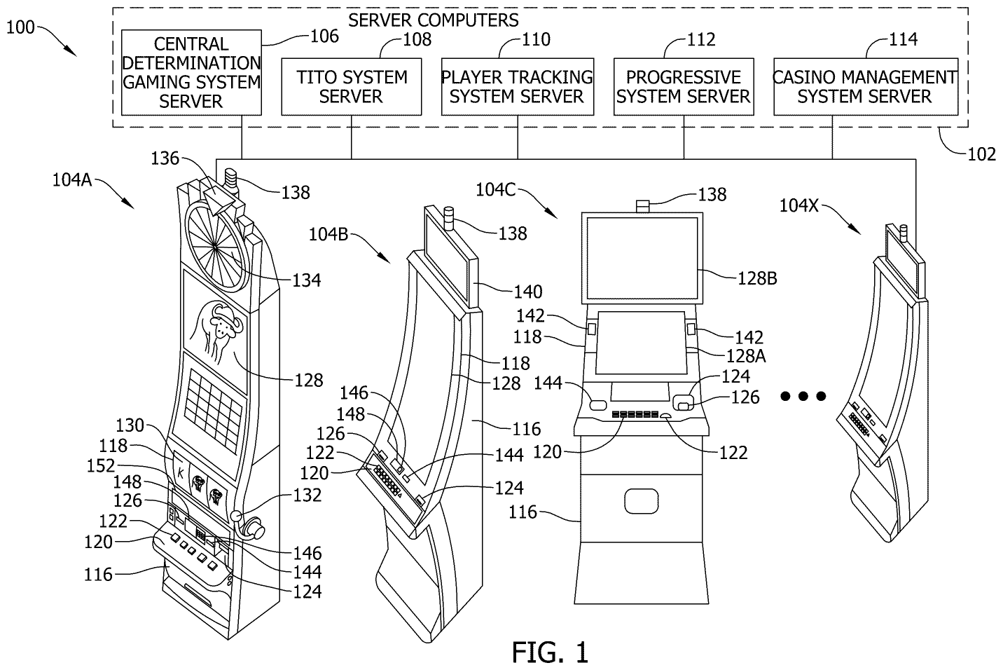

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

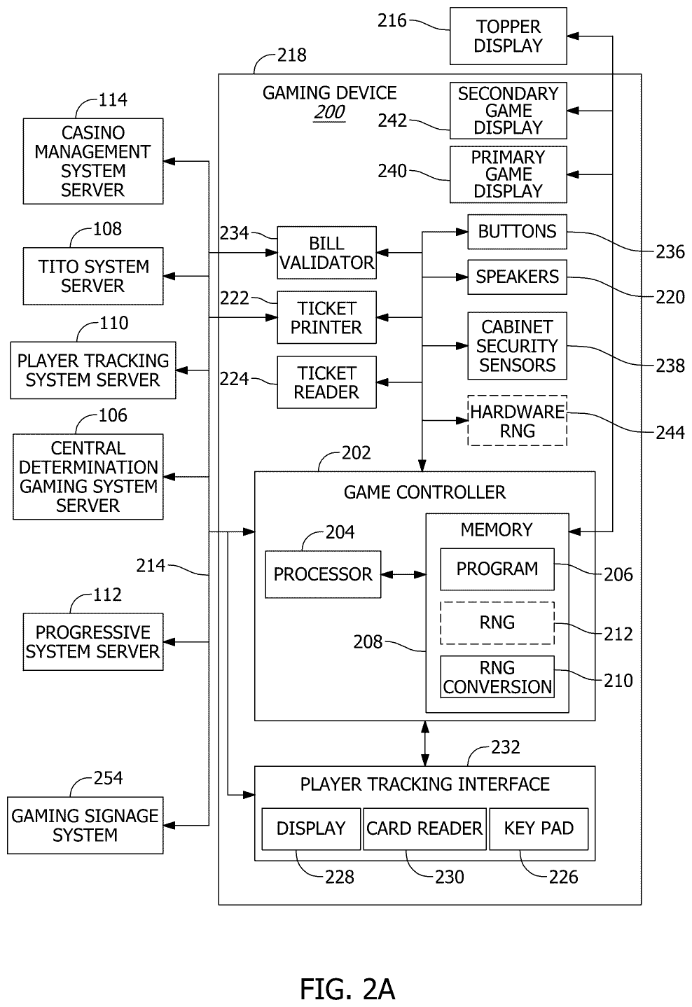

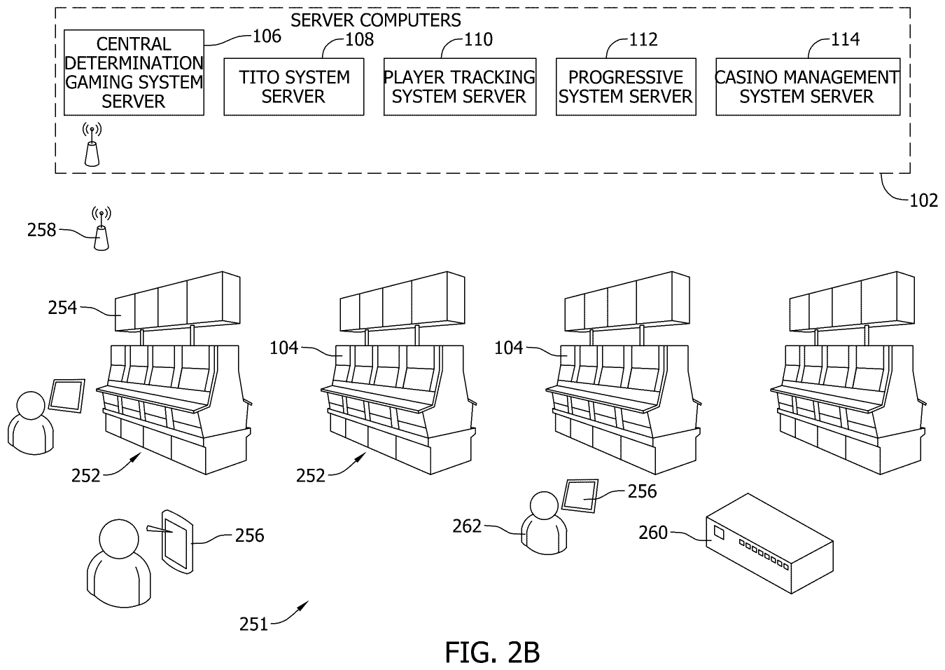

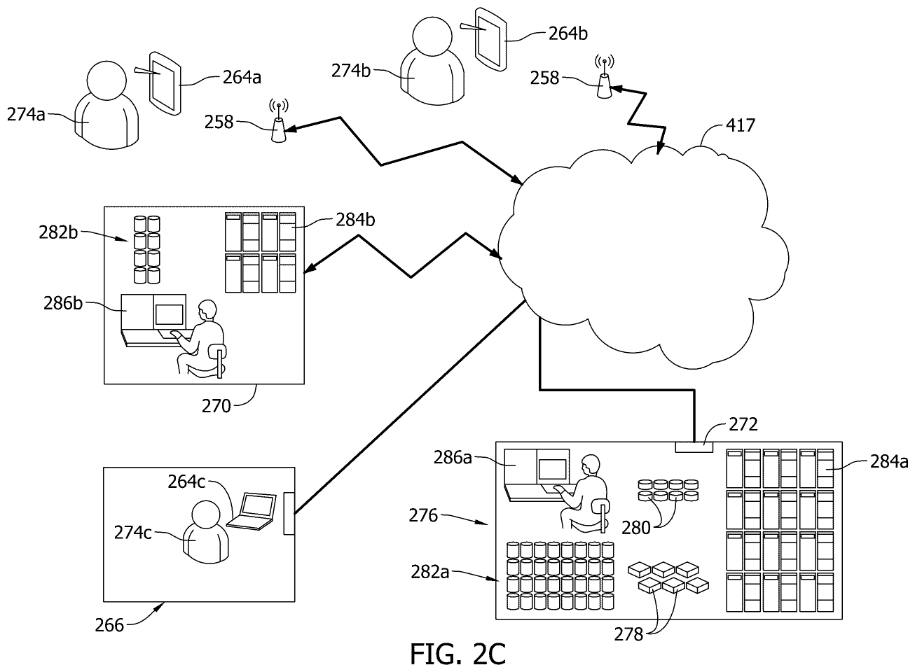

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

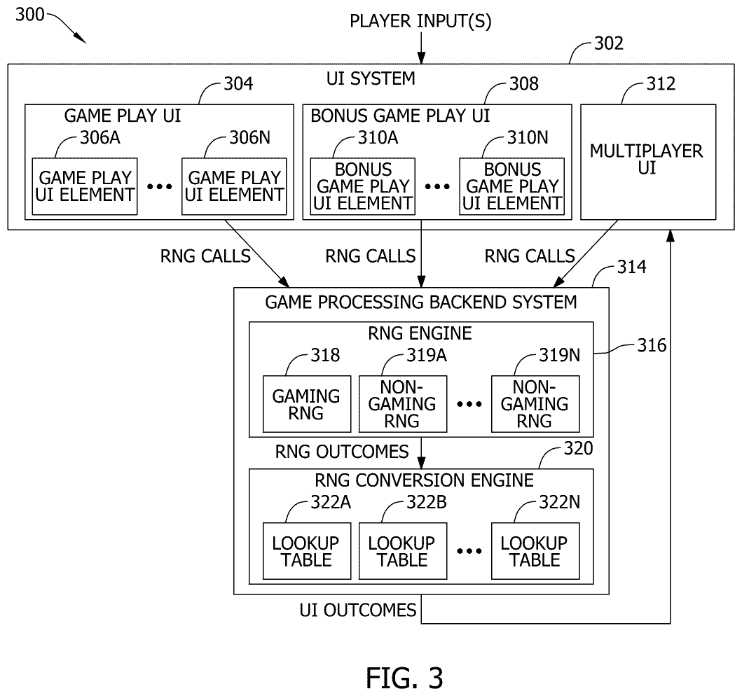

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-31ON for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

FIG. 4 illustrates an example screenshot and/or interface 400 of a base electronic game, as described herein. As shown in FIG. 4, a plurality of reels 402-410 are shown as including a plurality of rows 412-418. A plurality of symbols, including output symbols 420 (e.g., cash-on-reel (COR) symbols, what you see is what you get (WYSIWYG) symbols, or any other symbols associated with an output amount that is displayed thereon), are shown.

In the example embodiment, output symbols 420 are eligible to be provided on reels 404-410 (e.g., and not reel 402). In some embodiments, output symbols 420 may be provided on any of reels 402-410. In the example embodiment, output symbols 420 are not eligible to be provided on reel 402 because a trigger symbol (e.g., an activator symbol) is eligible to be provided on reel 402 (e.g., see trigger symbol 602, shown in FIG. 6). As explained in further detail herein, presentation of the trigger symbol on reel 402 causes a re-spin game to be triggered.

In the example embodiment, output symbols 420 are eligible to be provided on any row of plurality of rows 412-418. For each play of the base game, any previously provided output symbols 420 are caused to move up one row of plurality of rows 412-418 while new output symbols 420 may also be provided on any row of the plurality of rows 412. Any output symbols 420 provided in row 418 (e.g., the top row) for a play of the base game will move off of reels 402-410 for a next play of the base game. In some embodiments, output symbols 420 may move in any direction and by any number of positions. In other words, embodiments are envisioned where output symbols 420 move differently than up one row of plurality of rows 412-418 for each play (e.g., move left, move right, move down, move up, and by any number of positions).

For instance, FIG. 5 illustrates another example screenshot and/or interface 500 of the base game shown in FIG. 4. Notably, FIG. 5 illustrates a next play of the base game after the play shown in FIG. 4. Accordingly, output symbols 420 shown on rows 414, 416 in FIG. 4 are shifted up one row in FIG. 5. Output symbols 420 shown on row 418 in FIG. 4 are no longer shown as there is no row above row 418. Further, one additional output symbol 420, 502 was provided on row 412 for the next play.

For the next play of the base game shown in FIG. 5, reels 402-410 were re-spun. Any output symbols 420 carried through to FIG. 5 from FIG. 4 are overlaid upon reels 402-410 (e.g., and moved up one row of plurality of rows 412-418). In the example embodiment, symbols on reels 402-410 that are overlaid by output symbols 420 may be replaced by symbols of minimal value (e.g., to ensure higher value symbols are not overlaid by output symbols-thereby avoiding instances where a big win is missed out upon by higher value symbols being overlaid by output symbols 420). For instance, a weighted table stored in memory (e.g., an overlap symbol substitution table) may be utilized to determine which symbols will be used to replace certain symbols (e.g., Wild symbols) that are overlaid by output symbols 420.

FIG. 6 illustrates another example screenshot and/or interface 600 of the base game shown in FIG. 4. As noted above, FIG. 6 illustrates an example of trigger symbol 602 being provided on reel 402 for a play of the base game. In the example embodiment, when trigger symbol 602 is provided on reel 402, a re-spin game is provided.

FIG. 7 illustrates an example screenshot and/or interface 700 of the re-spin game being triggered from the base game shown in FIG. 4 (e.g., a transition from the base game to the re-spin game). Notably, message 702 is provided (e.g., after trigger symbol 602 is provided, as shown in FIG. 6) to communicate that the re-spin game has been triggered.

FIG. 8 illustrates an example screenshot and/or interface 800 of a re-spin game, as described herein. In the re-spin game, any output symbols 420 provided in the play of the base game that caused the re-spin game to be triggered are held in place for the re-spin game. For instance, output symbols 420 shown in FIG. 6 (e.g., the play of the base game that triggered the re-spin game) are shown in the same positions in FIG. 8. Trigger symbol 602 is also held in place.

In the example embodiment, trigger symbol 602 is held in place and reel 402 is locked for play of the re-spin game (e.g., reel 402 is not re-spun). Further, output symbols 420 displayed on reels 404-410 are held in place while reels 404-410 are re-spun for each play of the re-spin game. FIG. 8 illustrates an example where additional output symbols 420, 802 were provided as a result of a first play of the re-spin game. As shown in FIG. 8, a re-spin counter 804 is provided to communicate the number of re-spins that have occurred.

In the example embodiment, one play of the re-spin game is initially provided when the re-spin game is triggered. Additional plays of the re-spin game are provided until a play of the re-spin game results in no new output symbols 420 being provided. In other words, one additional play of the re-spin game is provided for each play of the re-spin game where a new output symbol 420 is provided, and the re-spin game ends when no new output symbols 420 are provided in a play of the re-spin game.

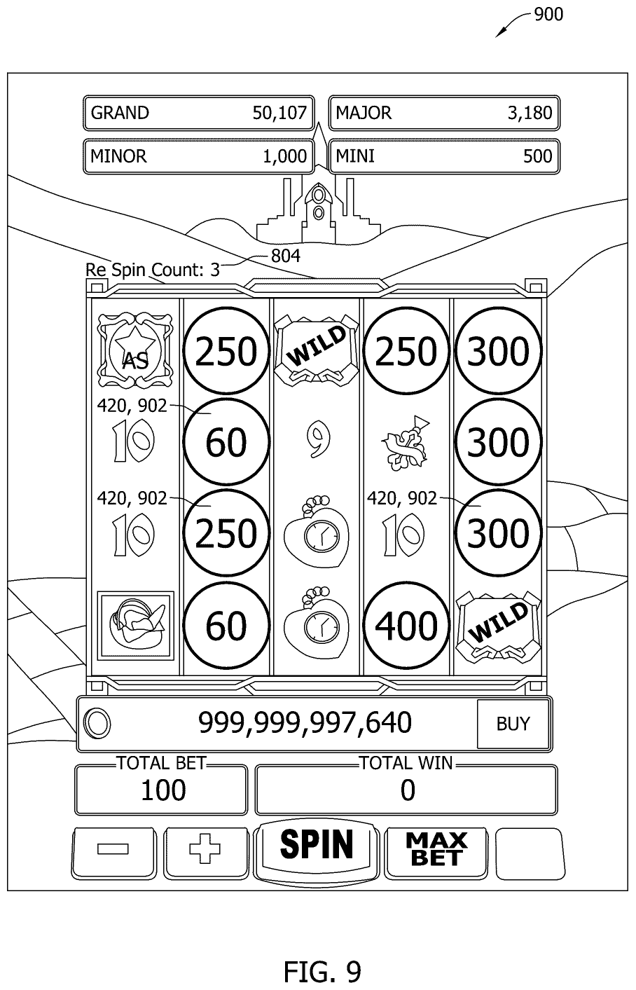

For instance, FIG. 9 illustrates an example screenshot and/or interface 900 of the re-spin game shown in FIG. 8. Counter 804 indicates that three plays of the re-spin game have been provided. New output symbols 420, 902 were provided for the second play and the third play of the re-spin game. Accordingly, the re-spin game advanced from the first play to the second play, from the second play to the third play, and will now advance from the third play to a fourth play.

FIG. 10 illustrates an example screenshot and/or interface 1000 of the re-spin game shown in FIG. 8. As shown, no new output symbols 420 were provided during the fourth play (e.g., see counter 804 now at four). Accordingly, the fourth play was the last play of the re-spin game.

When the re-spin game ends (e.g., a play of the re-spin game results in no new output symbols 420 being provided), output amounts associated with output symbols 420 displayed on reels 404-410 are summed and provided in a left to right cadence. In other words, output amounts associated with output symbols 420 may be provided for consecutive reels, from left-to-right, that have output symbols 420 displayed thereon (e.g., and not from output symbols 420 on reels to the right of any reel, other than reel 402 (e.g., displaying trigger symbol 602), that does not have an output symbol 420 displayed thereon).

Accordingly, in the example shown in FIG. 10, output symbols 420 are provided on reel 404, reel 408, and reel 410. Notably, no output symbols are provided on reel 406. Thus, because no output symbols are provided on reel 406, only output amounts associated with output symbols 420 provided on reel 404 are summed and presented. As shown, output symbols 420 on reel 404 are associated with 250 credits, 60 credits, 250 credits, and 60 credits respectively. Thus, the total number of credits to be provided is 620 credits.

FIG. 11 illustrates an example screenshot and/or interface 1100 of the re-spin game shown in FIG. 8. Continuing the above example in FIG. 10, a message 1102 is provided in FIG. 11 to communicate that a total win amount to be provided is 620 credits. 620 credits are similarly shown in win meter 1104 as an additional indication that 620 credits will be provided.

In the example embodiment, output symbols 420 displayed in a final play of the re-spin game are carried through to a first play of the base game once the re-spin game ends. In the example embodiment, output symbols 420 are carried through to the first play of the base game after the re-spin game ends regardless of whether or not output symbols 420 were associated with output amounts that were provided in the re-spin game. In other words, continuing the example in FIG. 10, output symbols 420 on reel 404, output symbols on reel 408, and output symbols 420 on reel 410 are all carried back to the base game (e.g., even though only output amounts associated with output symbols 420 on reel 404 were provided in the re-spin game).

Further, in the example embodiment, once output symbols 420 are carried from the re-spin game to the base game, output symbols 420 are shifted up one row for a first play of the base game after the re-spin game (e.g., just as would occur in between plays of the base game). As an example, screenshot and/or interface 400 illustrates an example outcome for a first play of the base game after the re-spin game outcome shown in FIG. 10. Accordingly, output symbols 420 from row 418 in FIG. 10 are not shown in FIG. 4 (e.g., as they have “floated” off of the matrix), output symbols 420 from row 416 in FIG. 10 are shown in row 418 of FIG. 4, output symbols 420 from row 414 in FIG. 10 are shown in row 416 of FIG. 4, and output symbols 420 from row 412 in FIG. 10 are shown in row 414 of FIG. 4.

FIG. 12 illustrates another example screenshot and/or interface 1200 of the re-spin game shown in FIG. 8. As shown in FIG. 12, trigger symbol 602 is displayed as being animated to indicate that the re-spin game has been triggered. Accordingly, output symbols 420 shown in FIG. 12 will be held for this iteration of the re-spin game.

FIG. 13 illustrates an example screenshot and/or interface 1300 of the re-spin game shown in FIG. 8. As shown in FIG. 13, a first play of the re-spin game has been provided. A message 1302 is shown to communicate that additional plays of the re-spin game will be provided for each play of the re-spin game where one or more additional output symbols 420 are provided.

As shown in FIG. 13, trigger symbol 602 remains animated to communicate that the re-spin game is occurring. Further, an animation 1304 is provided as surrounding reels 404-410 to communicate that reels 404-410 are re-spun in the re-spin game. Notably, animation 1304 does not surround reel 402 because reel 402 is not re-spun in the example embodiment of the re-spin game.

FIG. 14 illustrates an example screenshot and/or interface 1400 of the re-spin game shown in FIG. 12. As shown, FIG. 14 illustrates the outcome of a play of the re-spin game after the play shown in FIG. 13. Because no additional output symbols 420 were provided in the play shown in FIG. 14 (e.g., see no additional output symbols 420 in FIG. 14 when compared to FIG. 13), the re-spin game will end.

As explained herein, output amounts associated with output symbols 420 may be provided for consecutive reels, from left-to-right, that have output symbols 420 displayed thereon (e.g., and not from output symbols 420 on reels to the right of any reel, other than reel 402 (e.g., displaying trigger symbol 602), that does not have an output symbol 420 displayed thereon). Accordingly, in the example shown in FIG. 14, output amounts associated with output symbols 420 on reel 404 and reel 406 will be summed and provided, while output amounts associated with output symbols 420 on reel 410 will not be provided because no output symbols 420 are provided on reel 408.

To communicate that in this instance, only the sum of output amounts associated with output symbols 420 displayed on reel 404 and reel 406 will be provided, output symbols 420 displayed on reel 404 and reel 406 are displayed as being animated (e.g., glowing). Further, output symbols 420 on reel 410 are displayed as being dull (e.g., shaded) to communicate that output amounts associated with output symbols 420 on reel 410 will not be provided.

FIG. 15 illustrates an example screenshot and/or interface 1500 of the re-spin game shown in FIG. 12. As shown in FIG. 15, an animation 1502 is provided to communicate which output amounts are being summed and provided for this instance of the re-spin game. Animation 1502 may be provided one by one between a win meter 1504 and respective output symbols 420 associated with an output amount that will be provided. In other words, animation 1502 may first be shown between output symbol 420 on reel 404 and win meter 1504, then one by one between the respective output symbols 420 on reel 406 and win meter 1504. In the example embodiment, win meter 1504 is updated each time animation 1502 is displayed to show the addition of the output amount associated with the output symbol 420 from which animation 1502 extends from to win meter 1504.

FIG. 16 illustrates an example screenshot and/or interface 1600 of a free spin game being triggered from the base game shown in FIG. 4. In the example embodiment, the free spin game is triggered from the base game based upon a threshold number of scatter symbols 1602 being provided in an outcome of the base game. Accordingly, a message 1604 is displayed to indicate that the free spin game has been triggered and a number of free spins 1606 to be provided in the free spin game (e.g., twelve, as shown in FIG. 16). In the example embodiment, play of the free spin game corresponds to play of the base game, with the exception of the plays being free and not requiring an input amount be provided for each free play.

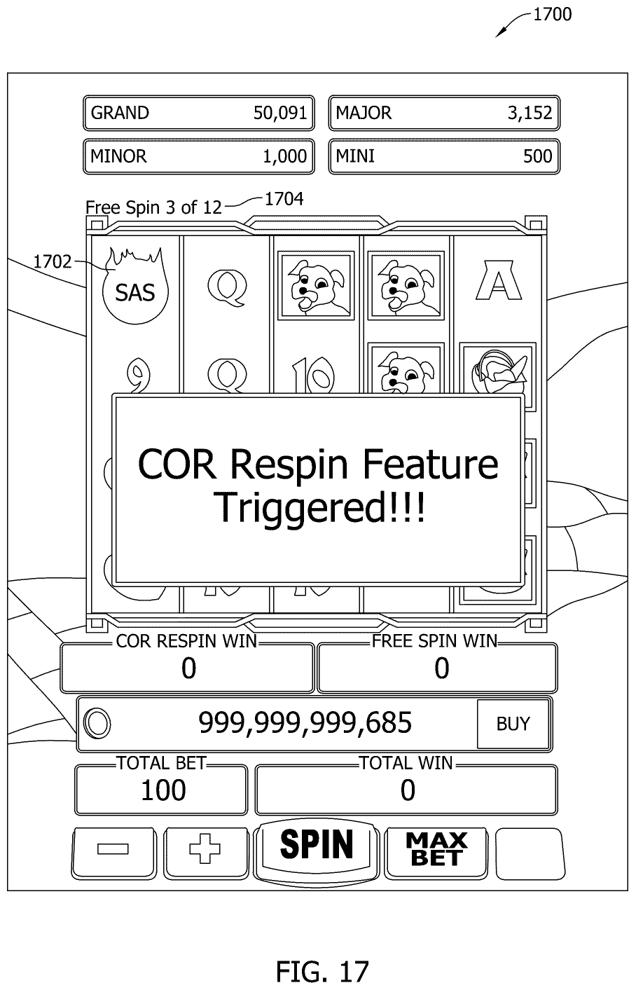

During play of the free spin game, the re-spin game described herein may be triggered. For instance, FIG. 17 illustrates an example screenshot and/or interface 1700 of the re-spin game being triggered from the free spin game triggered in FIG. 16. In the example embodiment, display of a trigger symbol 1702 (e.g., a super activator symbol (SAS)) in an outcome of the free spin game causes the re-spin game to be triggered within the free spin game. In the example shown in FIG. 17, trigger symbol 1702 was provided on a third free spin of twelve free spins, as shown in free spin counter 1704.

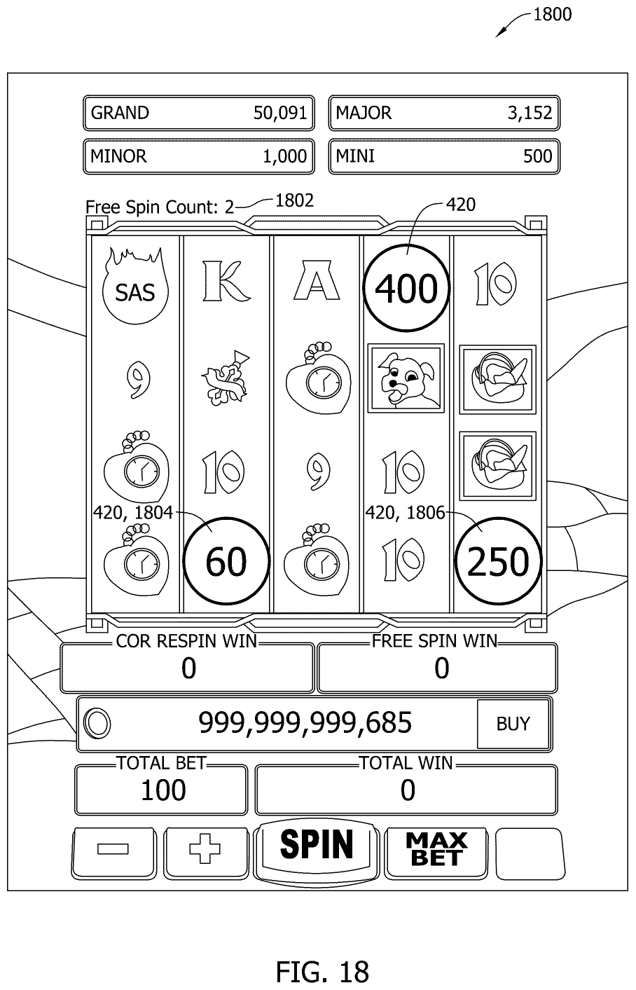

FIG. 18 illustrates an example screenshot and/or interface 1800 of the re-spin game triggered in FIG. 17. The example shown in FIG. 18 is a second re-spin in the re-spin game, as shown in re-spin counter 1802. As explained herein, output symbols 420 may be provided in the re-spin game and additional re-spins are provided after each play of the re-spin game where at least one additional output symbol 420 is provided.

In the example shown in FIG. 18, no new output symbols 420 were provided in the second re-spin. Accordingly, no more re-spins in the re-spin game will be provided.

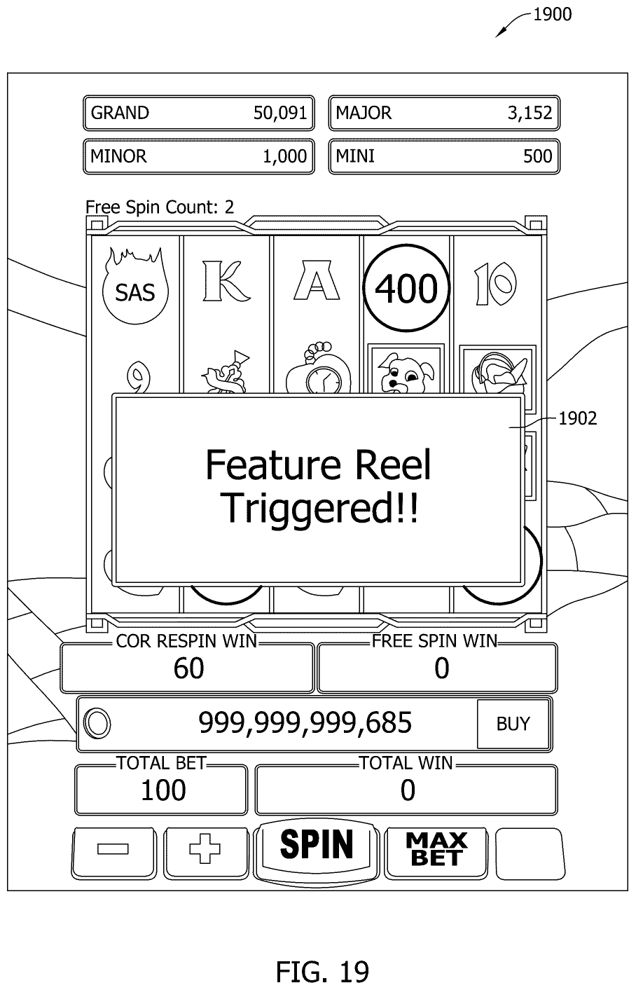

FIG. 19 illustrates another example screenshot and/or interface 1900 of the re-spin game shown in FIG. 18. As shown in FIG. 19, after a last re-spin in the re-spin game, a feature reel may be triggered, as indicated by message 1902. In the example embodiment, the feature reel may be a reel of multiplier amounts (e.g., or a multiplier slider) where a multiplier amount of the multiplier amounts on the reel is selected to be applied to a sum of output amounts associated with output symbols 420 that will be provided from the re-spin game (e.g., output amounts associated with output symbols 420 on consecutive reels, as described herein). Here, as shown in FIG. 18, reel 406 does not include an output symbol 420 thereon. Thus, only an output amount (e.g., 60 credits) associated with output symbol 420, 1804 will be provided (e.g., and have the multiplier applied thereto)

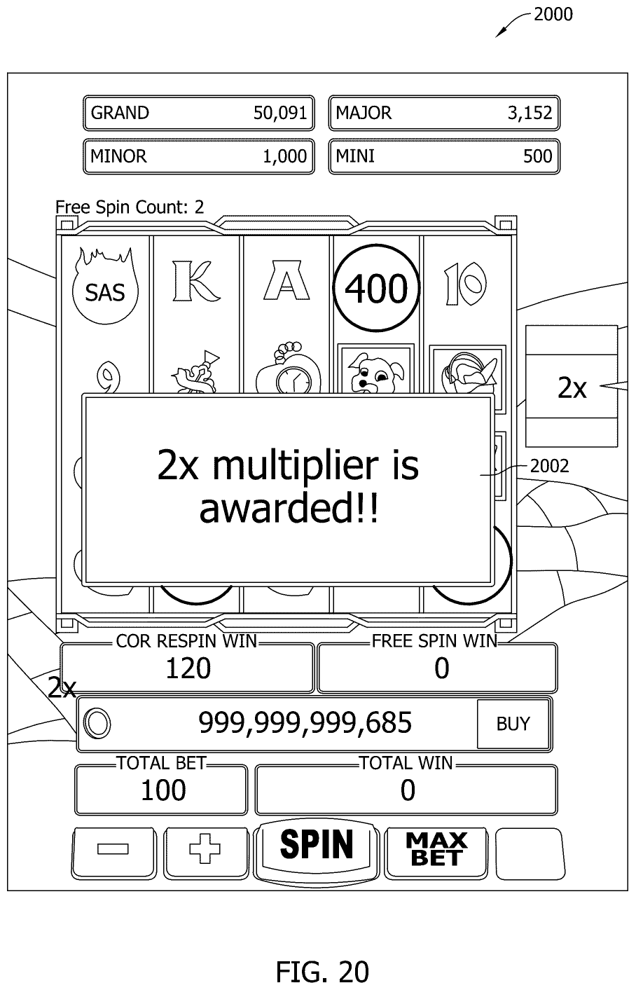

FIG. 20 illustrates another example screenshot and/or interface 2000 of the re-spin game shown in FIG. 18. As indicated by message 2002, a 2× multiplier was selected as a result from the feature reel.

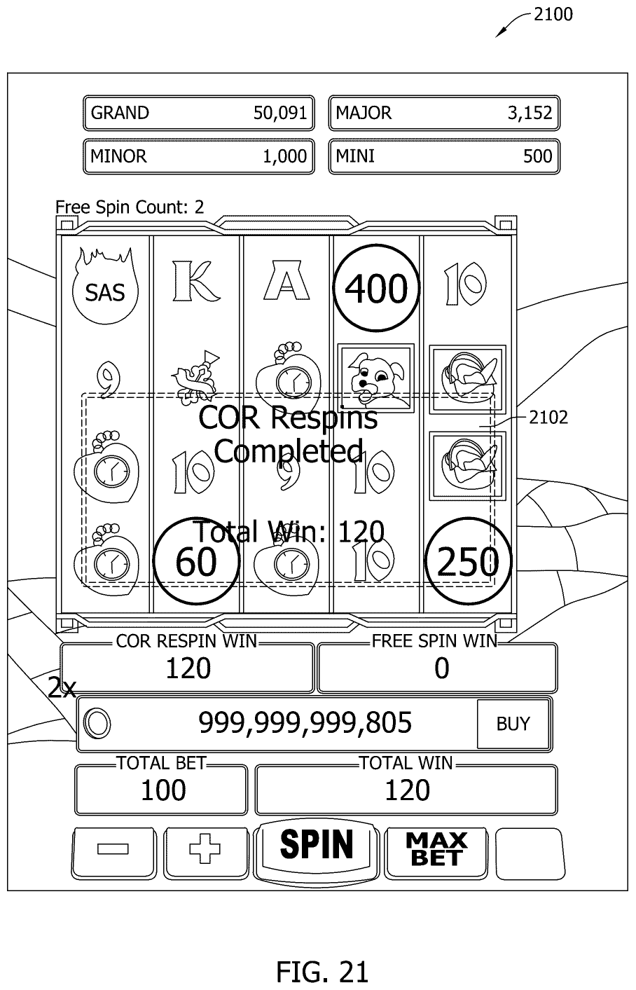

FIG. 21 illustrates another example screenshot and/or interface 2100 of the re-spin game shown in FIG. 18. As indicated by message 2102, the 2× multiplier (e.g., as shown in FIG. 19) is applied to the 60-credit amount associated with output symbol 420, 1804, resulting in a total of 120 credits being provided. Notably, re-spins in the re-spin game do not count as free spins in the free spin game. Further, output symbols 420 displayed in a last play of the re-spin game are carried back through to a next spin of the free spin game (e.g., and shifted up one row, as explained herein with respect to transitions from the re-spin game to the base game).

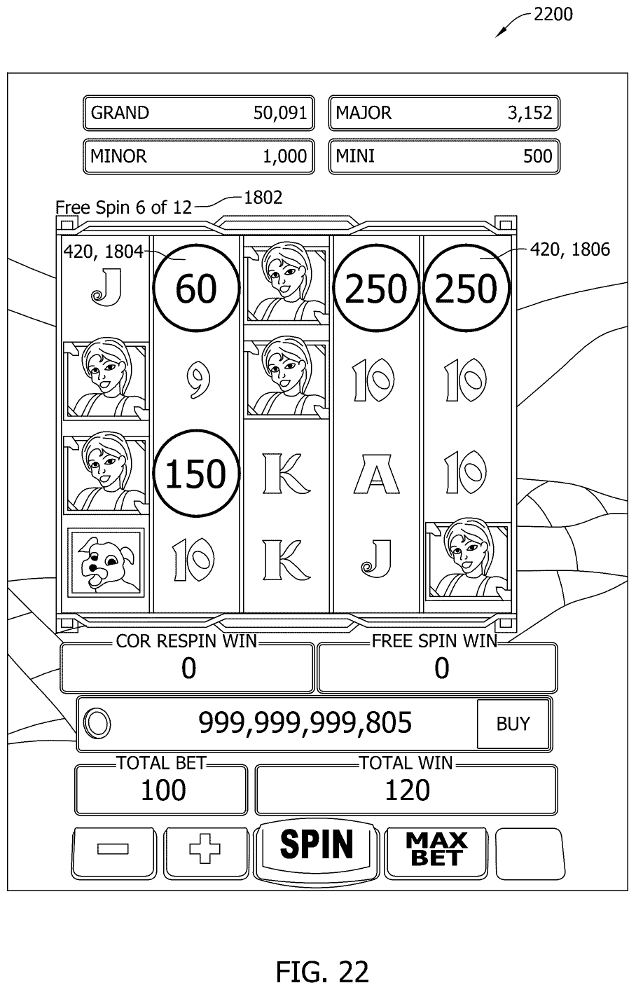

FIG. 22 illustrates an example screenshot and/or interface 2200 of the free spin game triggered in FIG. 16. FIG. 22 illustrates an example sixth spin in the free spin game, as shown in counter 1802. Further, output symbols 420, 1804 and 420, 1806 remain displayed after the transition from the re-spin game (e.g., output symbols 420, 1804 and 420, 1806 were shifted up one row for the fourth spin of the free spin game, shifted up one row for the fifth spin of the free spin game, and shifted up one row for the sixth spin of the free spin game).

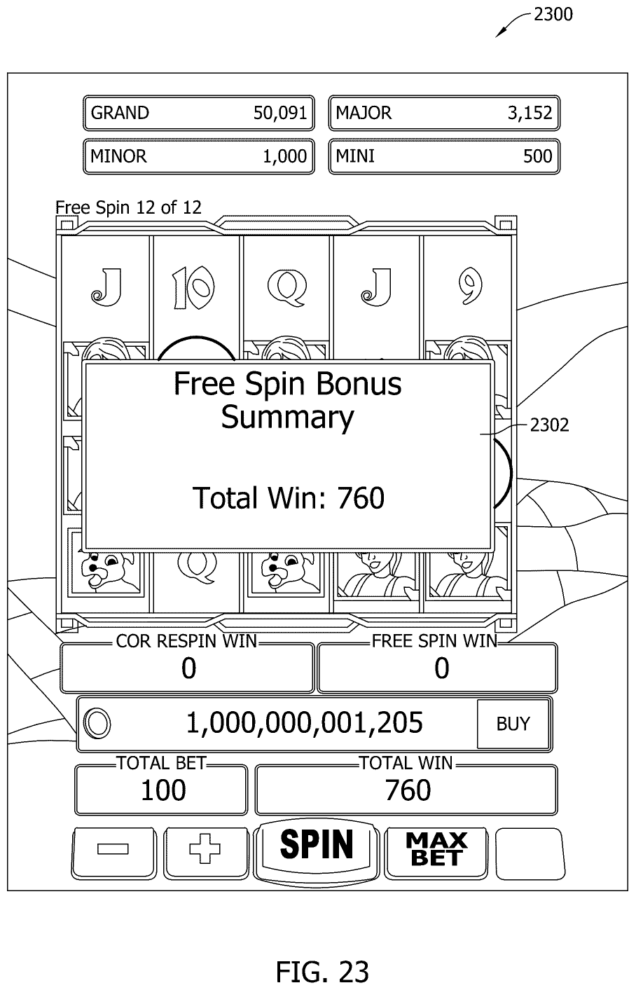

FIG. 23 illustrates another example screenshot and/or interface 2300 of the free spin game triggered in FIG. 16. FIG. 23 illustrates an example after a last free spin, free spin twelve, as indicated in counter 1802. As shown in message 2302, a total win of 760 credits will be provided as a result of the free spin game (e.g., the total number of credits resulting from payline evaluations during the free spin game and the outcome amount of 120 credits from the re-spin game within the free spin game).

FIG. 24 illustrates an example data structure and/or table 2400 for dynamically controlling displayed symbols, in accordance with the present disclosure. In the example embodiment, new reel strips may be determined for each reel 402-410 for each play of the base game, the re-spin game, and free spin game.

In the example embodiment, a custom reel set selection may be provided for each reel of the matrix. For instance, for each new spin, output symbols 420 may be “floated” (e.g., for the base game and the free spin game) and the state of reels 402-410 may be analyzed. The state of reels 402-410 may be analyzed as a sequence of bits, where each reel without an output symbol 420 thereon is represented by a “0” in the sequence and each reel with an output symbol 420 is represented by a “1” in the sequence. Notably, a bit is not provided for reel 402 as, in the example embodiment, reel 402 is not eligible to have an output symbol 420 displayed thereon.

The sequence may be concatenated (e.g., 0100 for reel 404 with no output symbol 420, reel 406 with an output symbol 420, reel 408 with an output symbol 420, and reel 410 with an output symbol 420).

The determined sequence may be used in combination with a randomly determined configuration for each reel (e.g., either configuration “A” or configuration “B,” where each configuration is a reel strip or plurality of symbols) and a weight table to randomly determine symbols for each symbol position of the reels.

For instance, as shown in FIG. 24, columns 2402 correspond to reel configurations (e.g., combinations of reel strip A and reel strip B) and rows 2404 correspond to different sequences of bits (e.g., representing the current state of output symbols 420 on reels 404-410). A reel set configuration selection is made based upon the randomly determined configuration for each reel 402-410 (e.g., reel strip A or reel strip B for each reel 402-410) and the sequence of bits for the current state of reels 404-410.

As shown in FIG. 24, different weights are provided in order to control the probabilities of certain symbols (e.g., output symbols) being provided as a way of controlling RTP. Notably, different tables (e.g., including different weights) may be provided in memory and accessed for each of the various electronic games described herein. Further, each of the different tables is specifically configured to control RTP across play of all of the electronic games provided herein (e.g., RTP of the game as a whole, including the base game, the re-spin game, and the free spin game).

In some embodiments, determined symbols that are overlaid by an output symbol may be replaced with a relatively low value symbol.

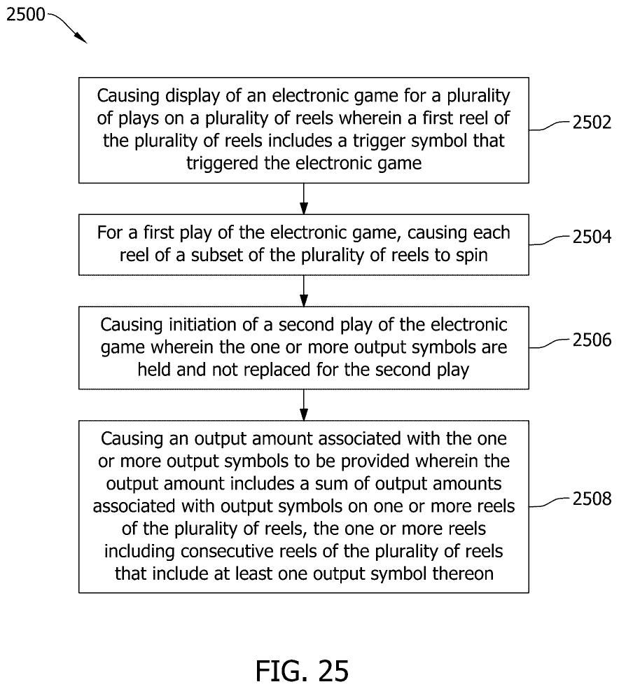

FIG. 25 illustrates an example method 2500 for dynamically controlling displayed symbols, in accordance with the present disclosure.

In the example embodiment, method 2500 includes causing display 2502 of an electronic game for a plurality of plays on a plurality of reels wherein the plurality of reels includes a plurality of symbols and wherein a first reel of the plurality of reels includes a trigger symbol that triggered the electronic game. Method 2500 also includes, for a first play of the electronic game, causing 2504 each reel of a subset of the plurality of reels to spin, the subset including each reel other than the first reel wherein one or more output symbols on the subset are held and not replaced for the first play and wherein symbols other than the one or more output symbols on the subset are replaced for the first play.

Method 2500 further includes, based on at least one additional output symbol being displayed for the first play, causing 2506 initiation of a second play of the electronic game wherein the one or more output symbols, including the at least one additional output symbol, are held and not replaced for the second play, and wherein symbols other than the one or more output symbols on the subset are replaced for the second play. Method 2500 also includes, after a last play of the plurality of plays, causing 2508 an output amount associated with the one or more output symbols to be provided wherein the output amount includes a sum of output amounts associated with output symbols on one or more reels of the plurality of reels, the one or more reels including consecutive reels of the plurality of reels that include at least one output symbol thereon.

In some embodiments, method 2500 includes identifying which reels of the subset of reels include at least one of the one or more output symbols thereon, randomly determining a reel configuration, from a plurality of reel configurations, for each reel of the subset of reels, and determining the symbols other than the one or more output symbols for the first play based upon one or more tables stored in memory, the reel configurations, and which reels of the subset of reels include at least one of the one or more output symbols thereon.

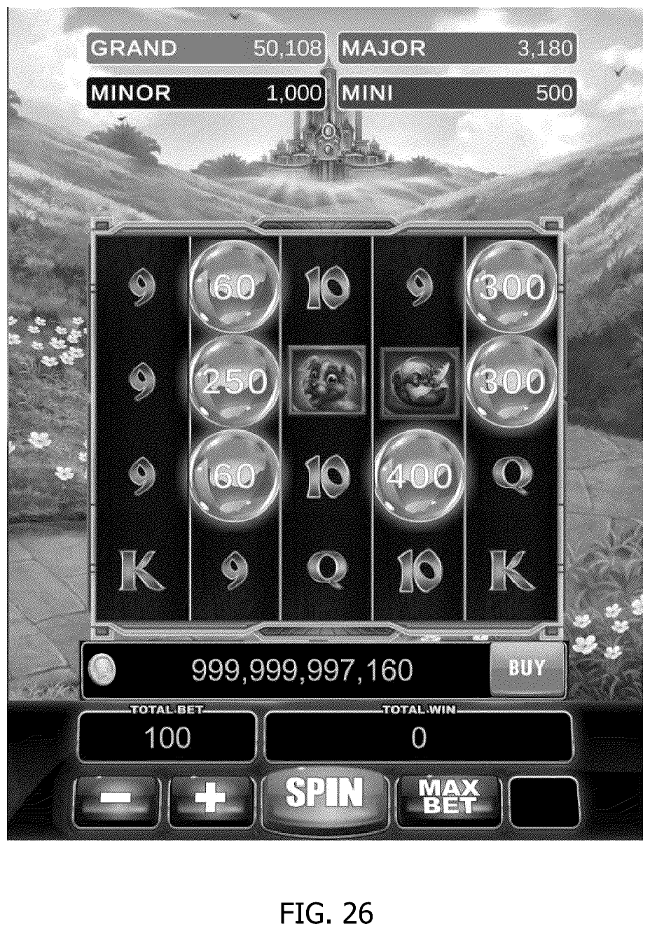

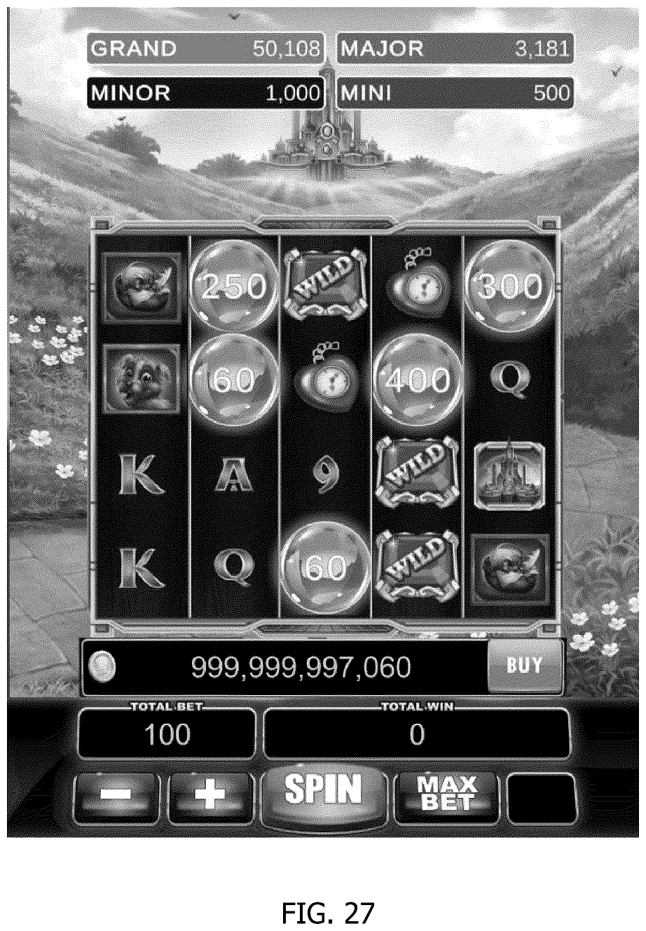

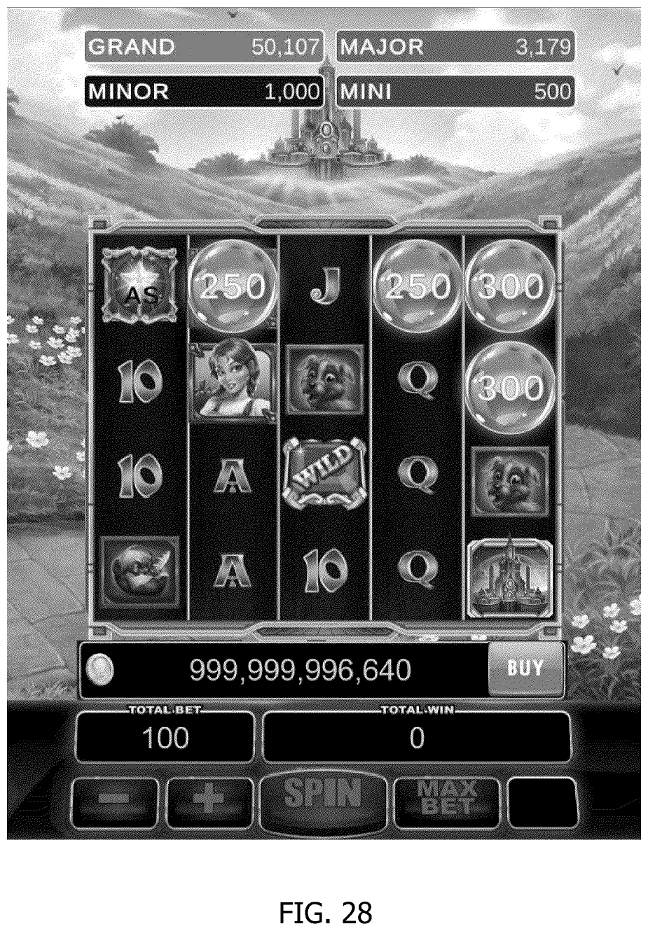

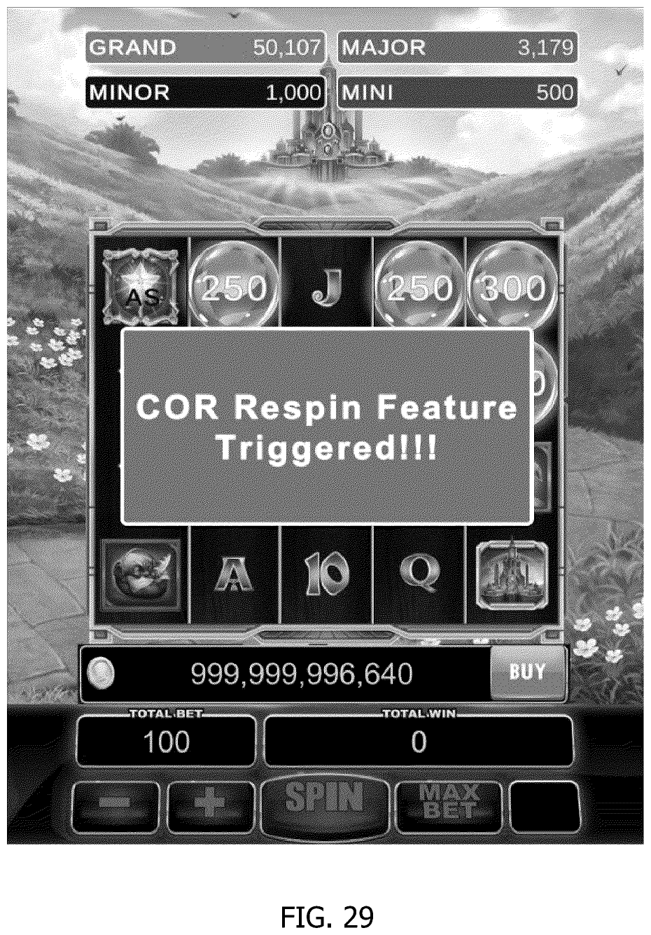

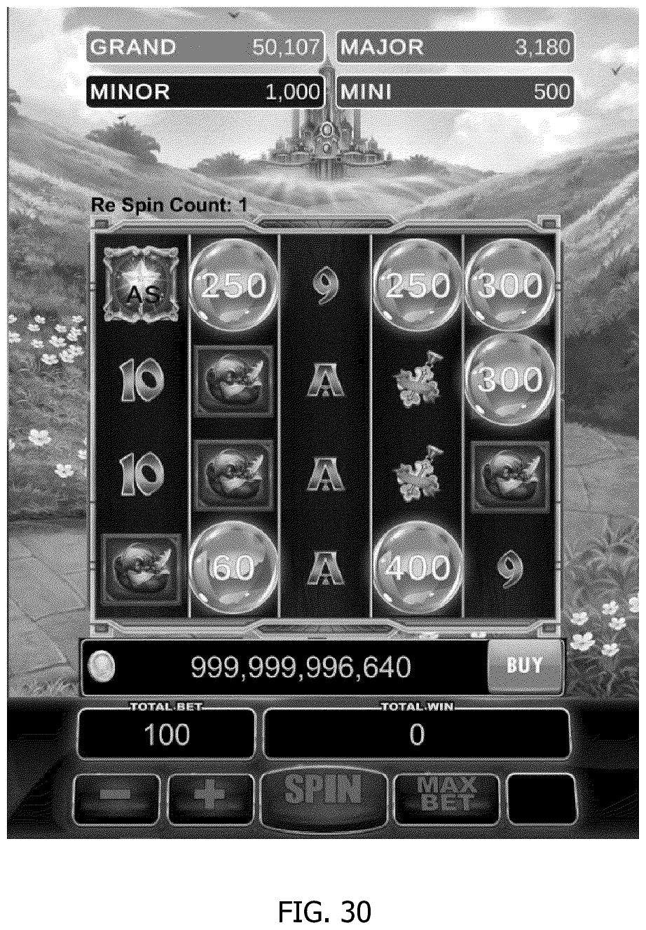

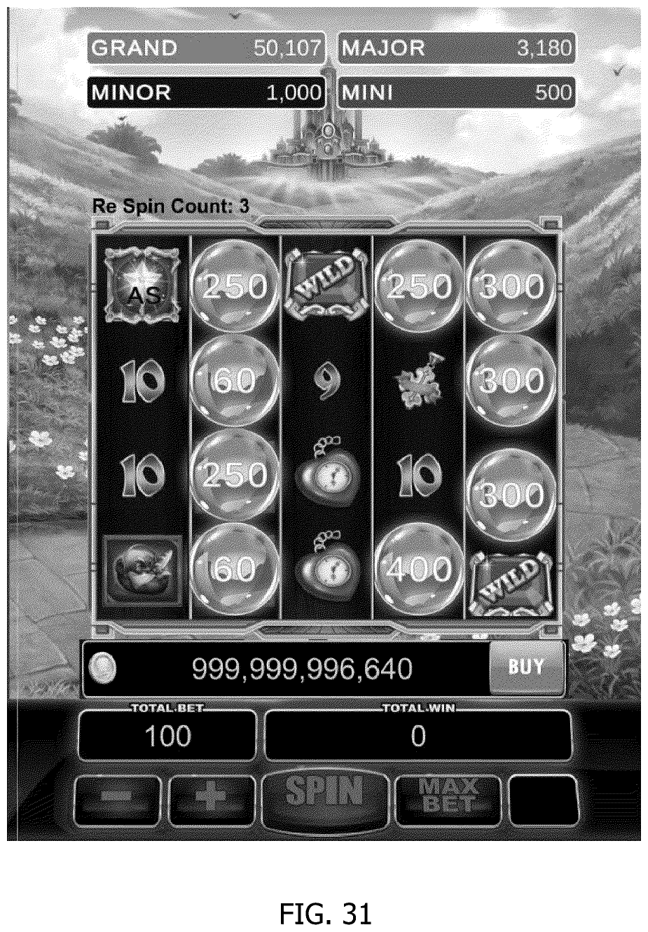

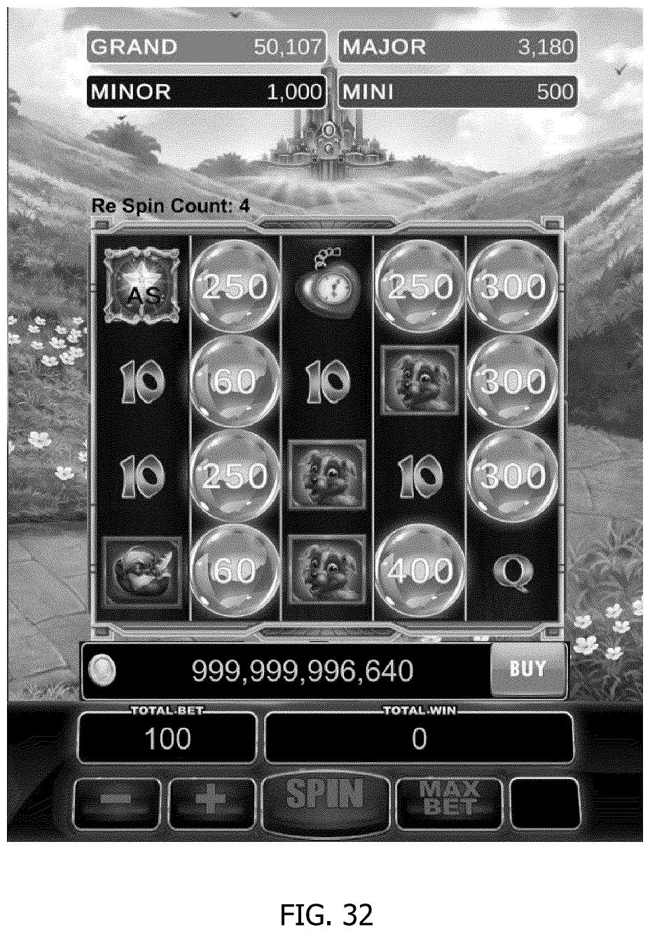

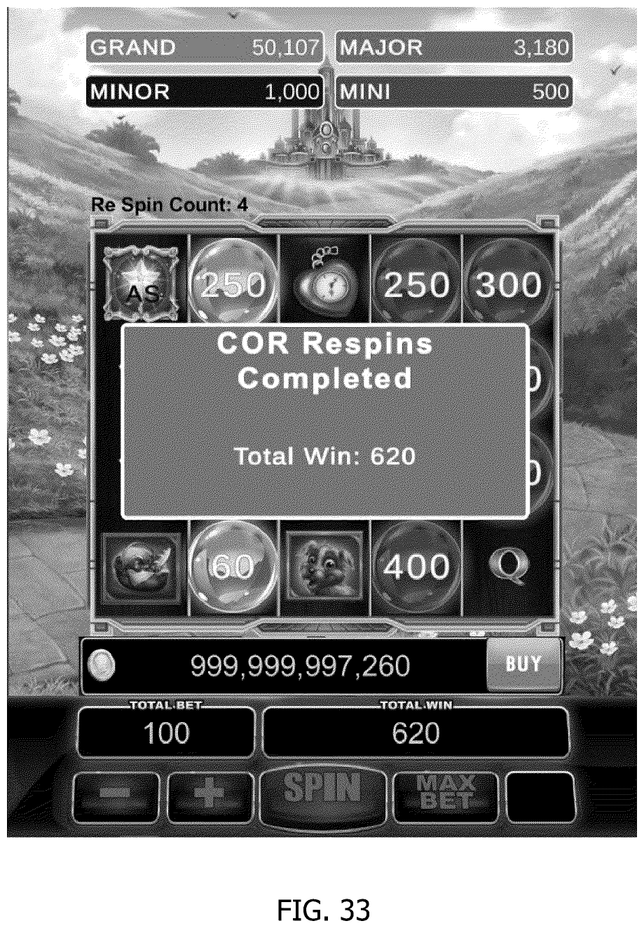

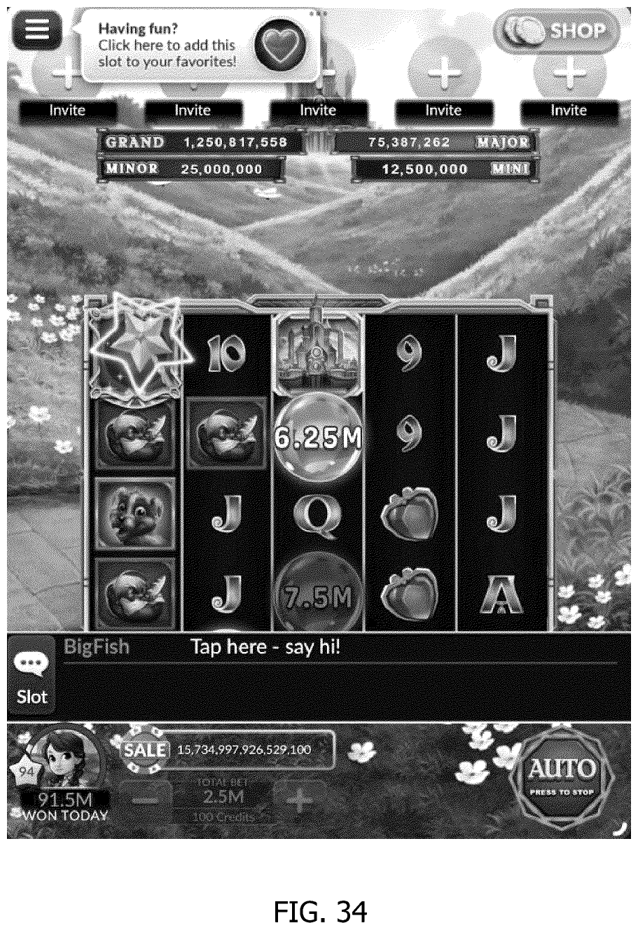

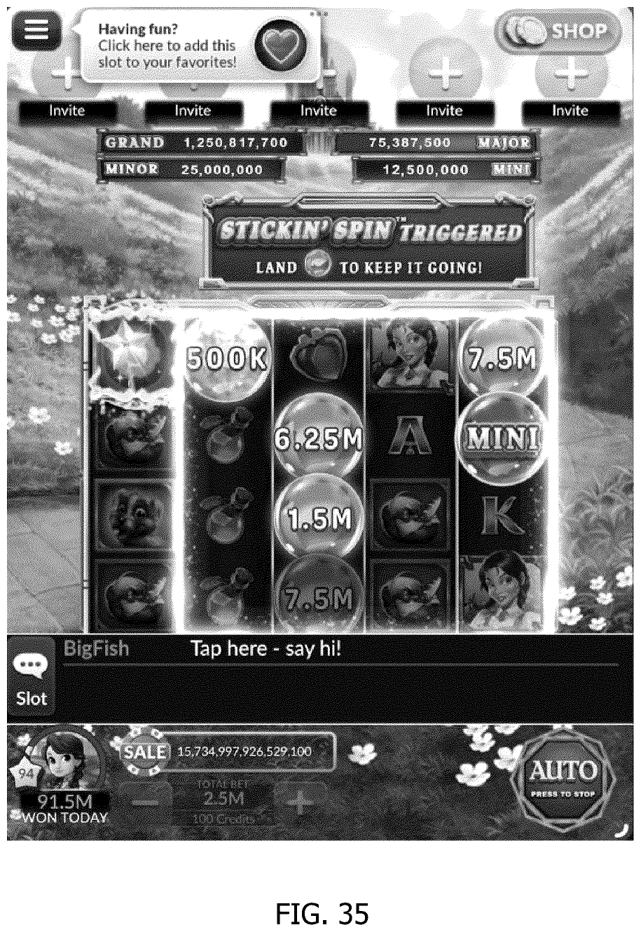

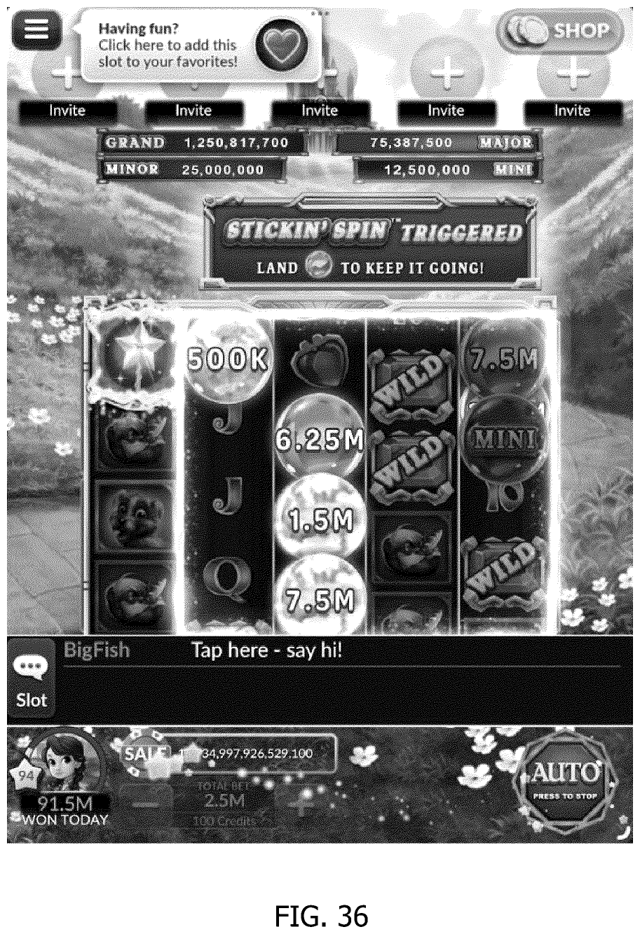

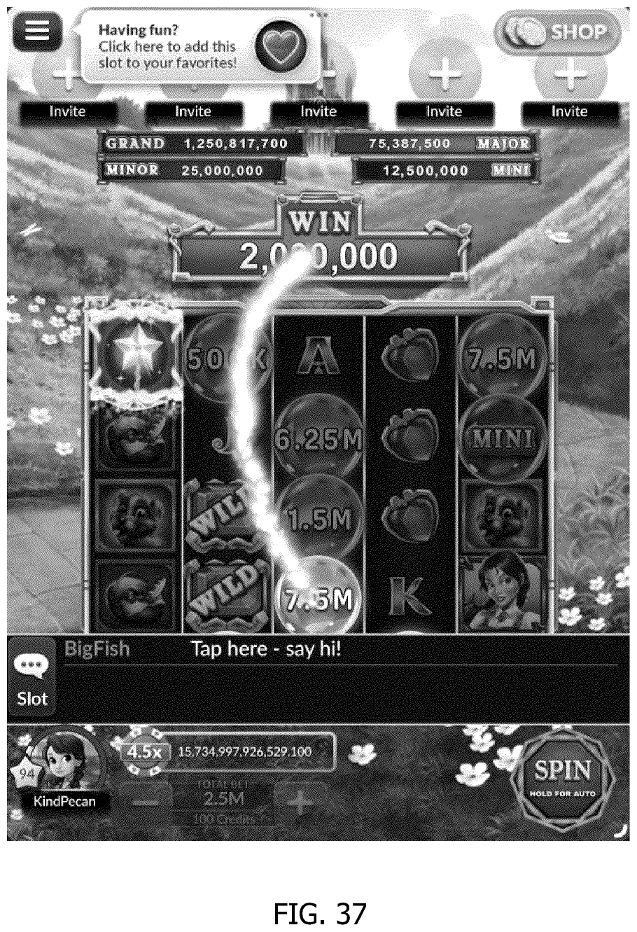

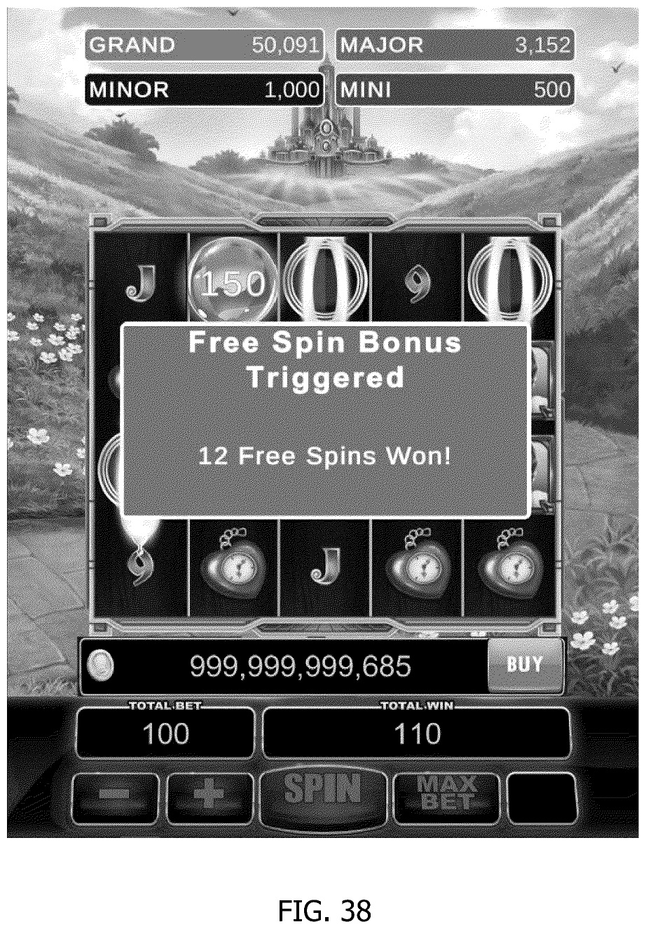

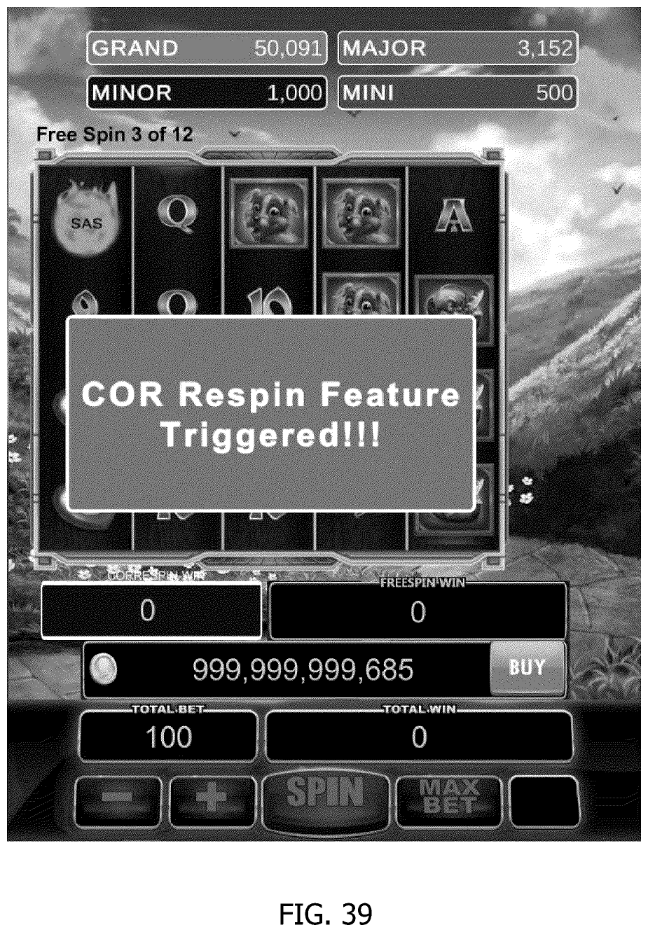

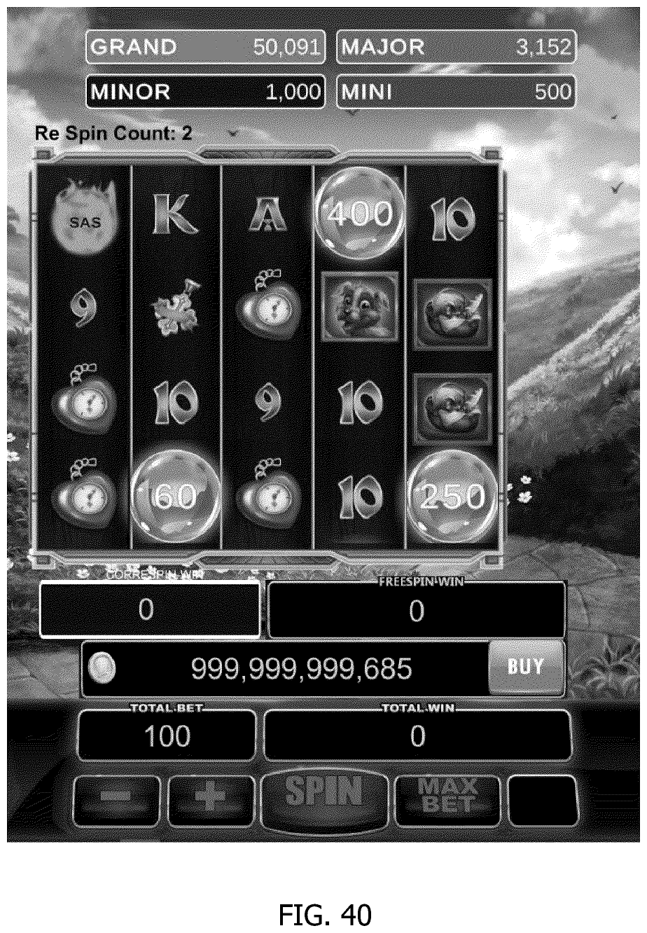

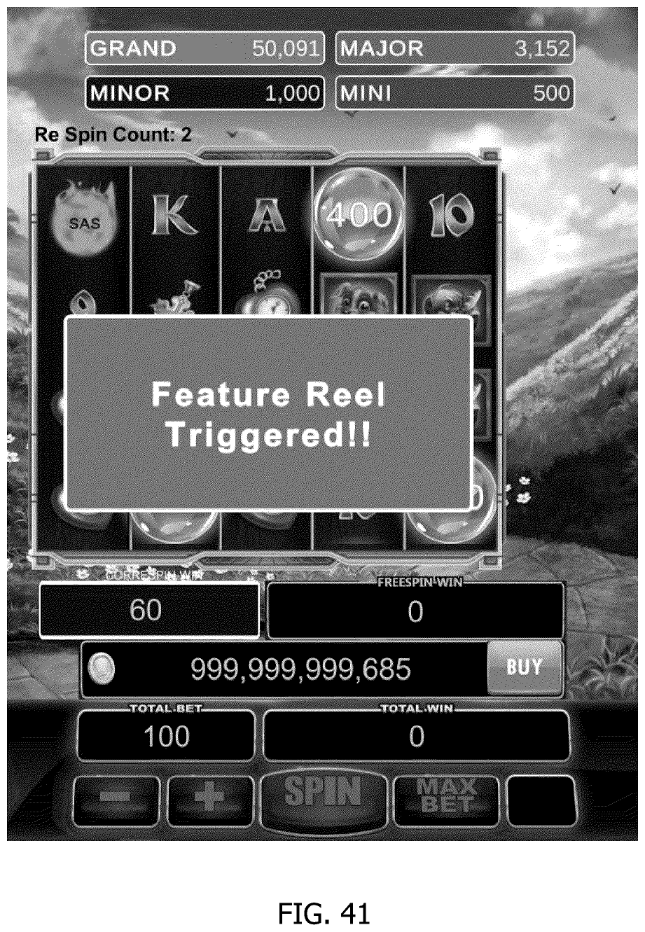

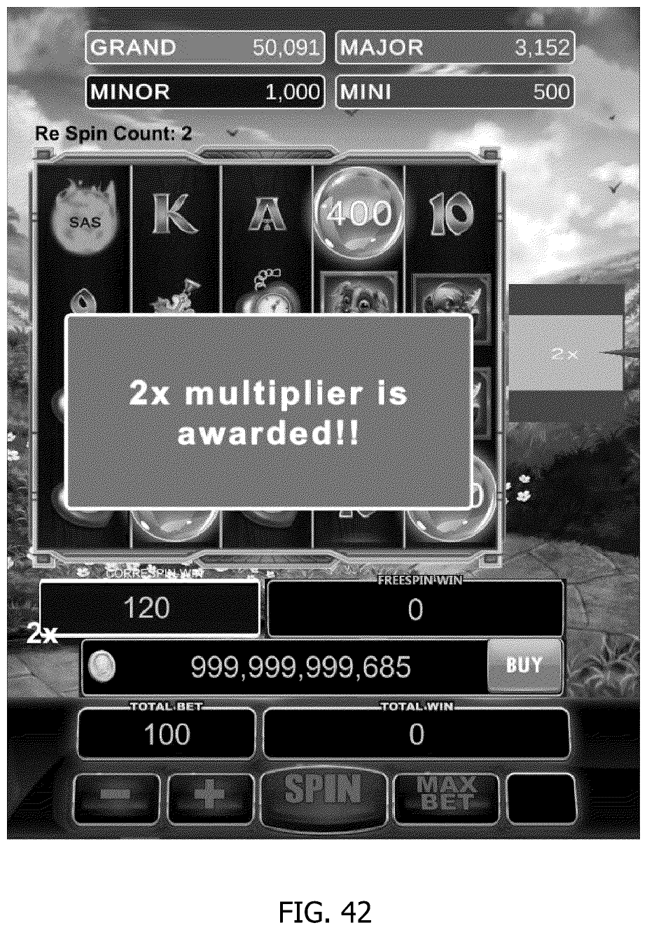

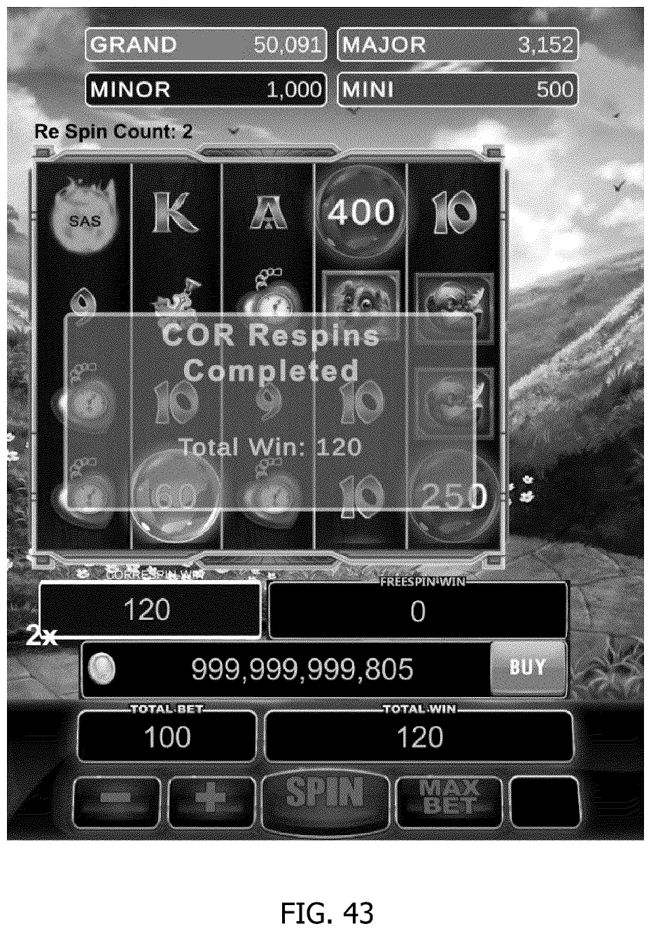

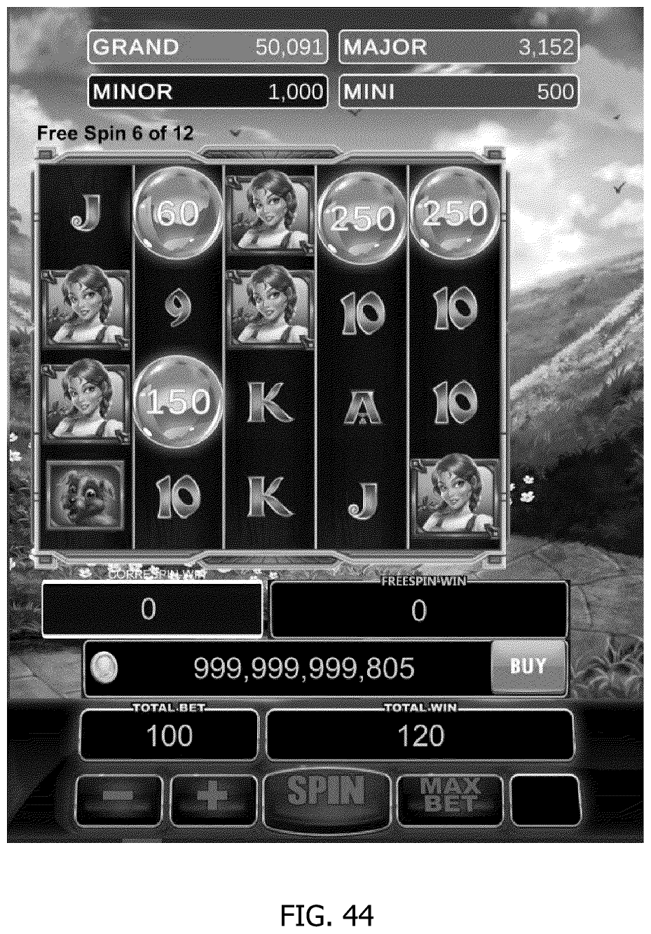

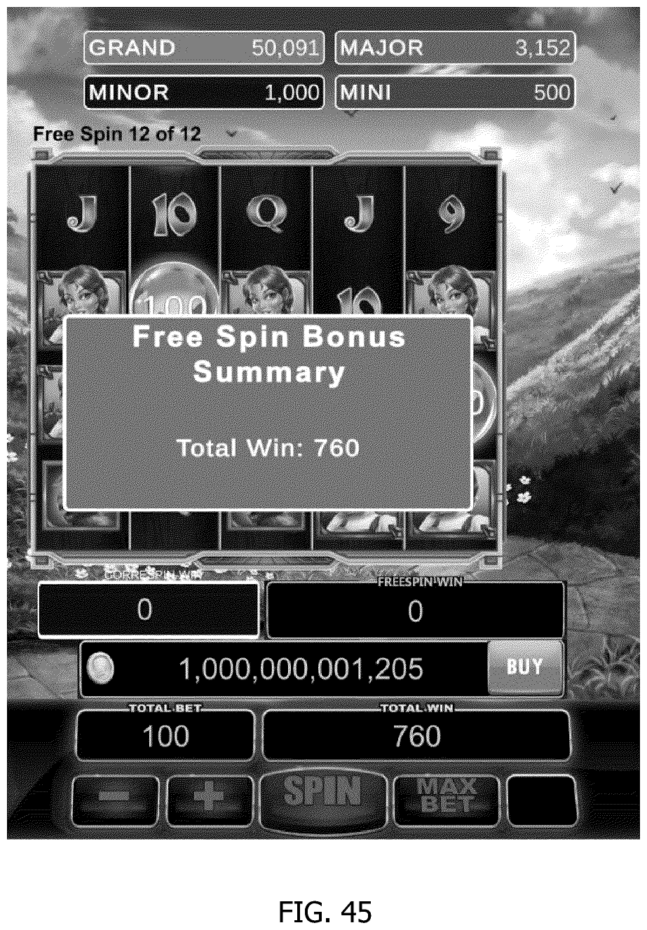

FIGS. 26-45 illustrate additional example screenshots and/or interfaces for dynamically controlling displayed symbols in electronic gaming, in accordance with the present disclosure.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming device comprising:
at least one memory with instructions stored thereon; and
at least one processor in communication with the at least one memory, wherein the instructions, when executed by the at least one processor, cause the at least one processor to:
cause display of an electronic game for a plurality of plays on a plurality of reels, wherein the plurality of reels comprise a plurality of symbols, and wherein a first reel of the plurality of reels comprises a trigger symbol that triggered the electronic game;
for a first play of the electronic game, cause each reel of a subset of the plurality of reels to spin, the subset comprising each reel other than the first reel, wherein one or more output symbols on the subset are held and not replaced for the first play, and wherein symbols other than the one or more output symbols on the subset are replaced for the first play;
based on at least one additional output symbol being displayed for the first play, cause initiation of a second play of the electronic game wherein the one or more output symbols, including the at least one additional output symbol, are held and not replaced for the second play, and wherein symbols other than the one or more output symbols on the subset are replaced for the second play; and
after a last play of the plurality of plays, cause an output amount associated with the one or more output symbols to be provided, wherein the output amount comprises a sum of output amounts associated with output symbols on one or more reels of the plurality of reels, the one or more reels comprising consecutive reels of the plurality of reels that include at least one output symbol thereon.

2. The electronic gaming device of claim 1, wherein the electronic game is a re-spin game that is triggered from a base game based upon the trigger symbol being included on the first reel during the base game.

3. The electronic gaming device of claim 2, wherein the instructions further cause the at least one processor to, after the output amount is provided, cause a transition from the re-spin game back to the base game, wherein at least some of the output symbols provided for the last play of the plurality of plays are provided for a first play of the base game after the re-spin game.

4. The electronic gaming device of claim 3, wherein the instructions further cause the at least one processor to cause the at least some of the output symbols to be provided for the first play of the base game by causing the at least some of the output symbols to move up one row from one or more respective rows the at least some of the output symbols were displayed upon for the last play of the re-spin game.

5. The electronic gaming device of claim 3, wherein the at least some of the output symbols includes at least one symbol associated with an output amount that was included in the sum of output amounts and at least one symbol associated with an output amount that was not included in the sum of output amounts.

6. The electronic gaming device of claim 1, wherein the instructions further cause the at least one processor to:
identify which reels of the subset of reels include at least one of the one or more output symbols thereon;
randomly determine a reel configuration, from a plurality of reel configurations, for each reel of the subset of reels; and
determine the symbols other than the one or more output symbols for the first play based upon one or more tables stored in memory, the reel configurations, and which reels of the subset of reels include at least one of the one or more output

7. The electronic gaming device of claim 1, wherein the instructions further cause the at least one processor to cause the last play of the plurality of plays to be a play of the plurality of plays in which no additional output symbol is provided.

8. The electronic gaming device of claim 1, wherein the instructions further cause the at least one processor to cause display of an animation on the subset of the plurality of reels to indicate that the subset of the plurality of reels are reels that will have the symbols other than the one or more output symbols on the subset replaced for the first play.

9. The electronic gaming device of claim 1, wherein the instructions further cause the at least one processor to cause display of an animation on each output symbol of the output symbols on the one or more reels whose respective output amount associated therewith will be included in the sum of output amounts.

10. At least one non-transitory computer-readable storage medium with instructions stored thereon that, in response to execution by at least one processor, cause the at least one processor to:
cause display of an electronic game for a plurality of plays on a plurality of reels, wherein the plurality of reels comprise a plurality of symbols, and wherein a first reel of the plurality of reels comprises a trigger symbol that triggered the electronic game;
for a first play of the electronic game, cause each reel of a subset of the plurality of reels to spin, the subset comprising each reel other than the first reel, wherein one or more output symbols on the subset are held and not replaced for the first play, and wherein symbols other than the one or more output symbols on the subset are replaced for the first play;
based on at least one additional output symbol being displayed for the first play, cause initiation of a second play of the electronic game wherein the one or more output symbols, including the at least one additional output symbol, are held and not replaced for the second play, and wherein symbols other than the one or more output symbols on the subset are replaced for the second play; and
after a last play of the plurality of plays, cause an output amount associated with the one or more output symbols to be provided, wherein the output amount comprises a sum of output amounts associated with output symbols on one or more reels of the plurality of reels, the one or more reels comprising consecutive reels of the plurality of reels that include at least one output symbol thereon.

11. The at least one non-transitory computer-readable storage medium of claim 10, wherein the electronic game is a re-spin game that is triggered from a base game based upon the trigger symbol being included on the first reel during the base game.

12. The at least one non-transitory computer-readable storage medium of claim 11, wherein the instructions further cause the at least one processor to, after the output amount is provided, cause a transition from the re-spin game back to the base game, wherein at least some of the output symbols provided for the last play of the plurality of plays are provided for a first play of the base game after the re-spin game.

13. The at least one non-transitory computer-readable storage medium of claim 12, wherein the instructions further cause the at least one processor to cause the at least some of the output symbols to be provided for the first play of the base game by causing the at least some of the output symbols to move up one row from one or more respective rows the at least some of the output symbols were displayed upon for the last play of the re-spin game.

14. The at least one non-transitory computer-readable storage medium of claim 12, wherein the at least some of the output symbols includes at least one symbol associated with an output amount that was included in the sum of output amounts and at least one symbol associated with an output amount that was not included in the sum of output amounts.

15. The at least one non-transitory computer-readable storage medium of claim 10, wherein the instructions further cause the at least one processor to:
identify which reels of the subset of reels include at least one of the one or more output symbols thereon;
randomly determine a reel configuration, from a plurality of reel configurations, for each reel of the subset of reels; and
determine the symbols other than the one or more output symbols for the first play based upon one or more tables stored in memory, the reel configurations, and which reels of the subset of reels include at least one of the one or more output symbols thereon.

16. The at least one non-transitory computer-readable storage medium of claim 10, wherein the instructions further cause the at least one processor to cause the last play of the plurality of plays to be a play of the plurality of plays in which no additional output symbol is provided.

17. The at least one non-transitory computer-readable storage medium of claim 10, wherein the instructions further cause the at least one processor to cause display of an animation on the subset of the plurality of reels to indicate that the subset of the plurality of reels are reels that will have the symbols other than the one or more output symbols on the subset replaced for the first play.

18. The at least one non-transitory computer-readable storage medium of claim 10, wherein the instructions further cause the at least one processor to cause display of an animation on each output symbol of the output symbols on the one or more reels whose respective output amount associated therewith will be included in the sum of output amounts.

19. A method of electronic gaming implemented by at least one processor in communication with at least one memory, the method comprising:
causing display of an electronic game for a plurality of plays on a plurality of reels, wherein the plurality of reels comprise a plurality of symbols, and wherein a first reel of the plurality of reels comprises a trigger symbol that triggered the electronic game;
for a first play of the electronic game, causing each reel of a subset of the plurality of reels to spin, the subset comprising each reel other than the first reel, wherein one or more output symbols on the subset are held and not replaced for the first play, and wherein symbols other than the one or more output symbols on the subset are replaced for the first play;
based on at least one additional output symbol being displayed for the first play, causing initiation of a second play of the electronic game wherein the one or more output symbols, including the at least one additional output symbol, are held and not replaced for the second play, and wherein symbols other than the one or more output symbols on the subset are replaced for the second play; and
after a last play of the plurality of plays, causing an output amount associated with the one or more output symbols to be provided, wherein the output amount comprises a sum of output amounts associated with output symbols on one or more reels of the plurality of reels, the one or more reels comprising consecutive reels of the plurality of reels that include at least one output symbol thereon.

20. The method of claim 19, further comprising:
identifying which reels of the subset of reels include at least one of the one or more output symbols thereon;
randomly determining a reel configuration, from a plurality of reel configurations, for each reel of the subset of reels; and
determining the symbols other than the one or more output symbols for the first play based upon one or more tables stored in memory, the reel configurations, and which reels of the subset of reels include at least one of the one or more output
